(19) United States
(12) Patent Application Publication
(10) Pub. No.: US 2013/0191118 A1
(43) Pub. Date: Jul. 25, 2013

(54) NOISE SUPPRESSING DEVICE, NOISE SUPPRESSING METHOD, AND PROGRAM

(71) Applicant: Sony Corporation, Tokyo (JP)

(72) Inventor: Kenichi MAKINO, Kanagawa (JP)

(73) Assignee: Sony Corporation, Tokyo (JP)

(21) Appl. No.: 13/719,696

(22) Filed: Dec. 19, 2012

(30) Foreign Application Priority Data
Jan. 19, 2012 (JP) 2012-009240

(51) Int. Cl. G10L 21/0216

(52) U.S. Cl. CPC G10L 21/0216
USPC 704/226

(57) ABSTRACT

Provided is a noise suppressing device including a framing unit that frames an input signal, a band division unit that obtains a band division signal, a band power computation unit that obtains a band power from each band division signal, a noise determination unit that determines whether each band is stationary noise or non-stationary noise, a noise band power estimation unit that estimates a band power of noise of each band, a noise suppression gain decision unit that decides a noise suppression gain of each band, a noise suppression unit that obtains a band division signal whose noise is suppressed, a band synthesis unit that obtains a framed signal whose noise is suppressed, and a frame synthesis unit that obtains an output signal whose noise is suppressed.

### BACKGROUND

The present disclosure relates to a noise suppressing device, a noise suppressing method, and a program, and particularly to a noise suppressing device, and the like which obtain an output signal obtained by selectively reducing a noise signal after estimating the noise signal from an input signal.

In recent years, VoIP (Voice over Internet Protocol) and electronic devices such as communication devices including mobile telephones, IC recorders and the like, which perform AD (Analog to Digital) conversion on the voice of a human collected using a microphone, and transmit and record the converted data as digital signals to reproduce the data, have become widely distributed. When such electronic devices are used, sound emitted from the surrounding environment is mixed in a microphone and interferes with audibility of a voice.

Thus, in the related art, a noise suppressing technology is adopted for mobile telephones, and the like, which estimates a noise signal from an input signal and selectively reduces the noise signal. This kind of the noise suppressing technology is disclosed in, for example, “Speech Enhancement Using a Minimum Mean Square Error Short-Time Spectral Amplitude Estimator” by Yariv Ephraim and David Malarah for IEEE Transactions on Acoustics, Speech, and Signal Processing, Vol. ASSP-32, No. 6, pp 1109-1121 of December 1994.

### SUMMARY

Noise includes stationary noise that does not entail a change in power and non-stationary noise that entails a change in power while having a spectral shape of noise, such as frictional noise including a sliding sound of clothes, a paper scraping sound, and the like, and the sound of wind.

It is desirable for the present disclosure to realize effective noise suppression not only for stationary noise but also non-stationary noise.

According to an embodiment of the present disclosure, there provided is a noise suppressing device including:

a framing unit that frames an input signal by dividing the input signal into frames having a predetermined frame length;

a band division unit that obtains a band division signal by dividing a framed signal obtained in the framing unit into a plurality of bands;

a band power computation unit that obtains a band power from each band division signal obtained in the band division unit;

a noise determination unit that determines whether each band is stationary noise or non-stationary noise based on a characteristic of the framed signal;

a noise band power estimation unit that estimates a band power of noise of each band from the band power of each band division signal obtained in the band power computation unit and a determination result of the noise determination unit;

a noise suppression gain decision unit that decides a noise suppression gain of each band based on the band power of each band division signal obtained in the band power computation unit and the band power of noise of each band estimated in the noise band power estimation unit;

a noise suppression unit that obtains a band division signal whose noise is suppressed by applying the noise suppression gain of each band decided in the noise suppression gain decision unit to each band division signal obtained in the band division unit;

a band synthesis unit that obtains a framed signal whose noise is suppressed by performing band synthesis on each band division signal obtained in the noise suppression unit; and

a frame synthesis unit that obtains an output signal whose noise is suppressed by performing frame synthesis on the framed signal of each frame obtained in the band synthesis unit.

The noise band power estimation unit increases speed of following a noise change in the non-stationary noise to be higher than speed of following a noise change in the stationary noise.

According to an embodiment of the present disclosure, the framing unit frames an input signal by dividing the input signal into frames having a predetermined length of time. Then, the framed signal is divided into a plurality of bands by the band division unit to obtain a band division signal. For example, in the band division unit, a fast Fourier transform is performed on the framed signal to obtain a frequency domain signal, and then divided into a plurality of bands.

By the band power computation unit, a band power is obtained from each band division signal obtained in the band division unit. In this case, for example, a power spectrum is computed from a complex spectrum obtained in the Fourier transform, and the maximum value or the average value in bands of the power spectrums is set as a representative value, that is, a band power.

The noise determination unit determines whether each band is stationary noise or non-stationary noise based on the characteristics of a framed signal. In other words, the noise determination unit determines whether each band is stationary noise, non-stationary noise, or a voice. For example, when each band is sequentially set as a determination band, the band powers of a current frame and the previous frame of a band division signal of the determination band are compared, and a change in the band power occurs within a threshold value, the determination band is determined to be stationary noise. This determination is based on the assumption that the power of noise is constant in frames, and in contrast, that a signal of which the power greatly changes is not of noise. In addition, for example, when each band is sequentially set as a determination band, a framed signal has the characteristics of non-stationary noise, and when the peak resulting from a voice is not present in the determination band, the determination band is determined to be of non-stationary noise.

The noise band power estimation unit estimates the noise band power of each band from the band power of each band division signal obtained in the band power computation unit and a determination result of the noise determination unit. In this case, the speed of following changes in non-stationary noise increases more than the speed of following changes in stationary noise. For example, the noise band power estimation unit obtains the estimated power of noise of a current frame by performing weighted addition on the band power of the current frame obtained in the band power computation unit and the band power of noise estimated in one frame before the current frame for each band, and the weight of the band power of the current frame in non-stationary noise is set greater than the weight of the band power of the current frame in stationary noise.

The noise suppression gain decision unit decides the noise suppression gain of each band based on the band power of each band division signal obtained in the band power computation unit and the band power of noise of each band estimated in the noise band power estimation unit. Then, the noise suppression unit obtains a band division signal in which noise is suppressed by applying the noise suppression gain of each band decided in the noise suppression gain decision unit to each band division signal obtained in the band division unit. Then, the band synthesis unit obtains a framed signal in which noise is suppressed by performing band synthesis on each band division signal obtained in the noise suppression unit, and the frame synthesis unit performs frame synthesis on the framed signal of each frame obtained in the band synthesis unit to obtain an output signal in which noise is suppressed.

In this way, according to the present disclosure, when the noise band power of each band is estimated in the noise band power estimation unit, the speed of following a change in the non-stationary noise increases more than the speed of following a change in the stationary noise. Since a signal of non-stationary noise changes faster than that of stationary noise, but the speed of following noise is accelerated in non-stationary noise, the performance of following non-stationary noise improves. Therefore, effective noise suppression can be realized not only for stationary noise but also for non-stationary noise.

According to the present disclosure, for example, the noise suppression gain decision unit may be configured to have an SNR computation section that computes an SNR from the band power of each band division signal obtained in the band power computation unit and the band power of noise of each band estimated in the noise band power estimation unit for each band, and an SNR smoothing section that performs smoothing on an SNR computed for the SNR computation section for each band.

In this case, in the noise suppression gain decision unit, the noise suppression gain of each band is decided based on an SNR of each band smoothed in the SNR smoothing section. In addition, in this case, a smoothing coefficient is changed based on a determination result of the noise determination unit and a frequency band. For example, in the noise suppression gain decision unit, the noise suppression gain of each band may set to be determined based on the SNR of each band smoothed in the SNR smoothing section and the SNR computed in the SNR computation section.

In addition, for example, in the noise suppression gain decision unit, the ratio of the band power of a signal of a current frame to the estimated band power of noise is set to be a first SNR and the ratio of the amount obtained by multiplying the band power of a signal of the previous frame by a noise suppression gain to the estimated band power of noise of the previous frame is set to be a second SNR for each band. In addition, in the noise suppression gain decision unit, a noise suppression gain is decided using the first SNR and the second SNR.

In this way, in the noise suppression gain decision unit, for example, the noise suppression gain is decided based on the smoothing SNR for each band, but the smoothing coefficient is changed based on the determination result of the noise determination unit and a band. For example, for each frame and each band, the smoothing coefficient (a) changes to have a small value when the determination band is determined to be non-noise and the smoothing coefficient (a) changes to have a large value when the determination band is determined to be noise. Accordingly, a following capability of the smoothing SNR can be improved at a period in which a time variation of signal is large. Alternatively, an unnecessary change of the smoothing SNR can be suppressed in a period in which a time variation of signal is small. For this reason, the accuracy of the noise suppression gain of each band can be improved and deterioration of the quality of sound can be suppressed such that the quality of sound little deteriorates.

In addition, according to the present disclosure, when a noise suppression gain decided in the noise suppression gain decision unit is smaller than the lower limit value set in advance, for example, the noise suppression gain modification unit that modifies the value of the noise suppression gain to be the lower limit value may be further provided, and the noise suppression unit may use the noise suppression gain modified in the noise suppression gain modification unit.

In this case, the lower limit value is set for each band. When a signal of non-noise is a voice, for example, the lower limit value of a noise suppression gain is set to be a higher value for a band with a high probability of including a voice signal. In addition, when a noise suppression gain decided in the noise suppression gain decision unit is lower than the lower limit value, the gain is replaced by the lower limit value. Therefore, the quality of sound in terms of the auditory sense deteriorates little even if there is an error of a noise suppression gain decided in the noise suppression gain decision unit.

According to an embodiment of the present disclosure, there provided is a noise suppressing device including:

a plurality of framing units that perform framing by performing division into frames having predetermined frame lengths of a respective plurality of channels;

a plurality of band division units that obtain band division signals by dividing framed signals obtained in the plurality of framing units into a plurality of bands, respectively;

a plurality of band power computation units that obtain band powers from the respective band division signals obtained in the plurality of band division units;

a noise determination unit that determines whether each band is stationary noise or non-stationary noise based on characteristics of the framed signals of the plurality of channels;

a plurality of noise band power estimation units that estimate band powers of noise of respective bands from the band powers of respective band division signals obtained in the plurality of band power computation units and a determination result of the noise determination unit;

a plurality of noise suppression gain decision units that decide noise suppression gains of respective bands based on the band powers of the respective band division signals obtained in the plurality of band power computation units and the band powers of noise of the respective bands estimated in the plurality of noise band power estimation units;

a plurality of noise suppression units that obtain band division signals whose noise is suppressed by applying noise suppression gains of the respective bands decided in the plurality of noise suppression gain decision units to the respective band division signals obtained in the plurality of band division units;

a plurality of band synthesis units that obtain framed signals whose noise is suppressed by performing band synthesis on the respective band division signals obtained in the plurality of noise suppression units; and

a frame synthesis unit that obtains output signals whose noise is suppressed by performing frame synthesis on the framed signals of respective frames obtained in the plurality of band synthesis units.

The noise band power estimation unit increases speed of following a noise change in the non-stationary noise to be higher than speed of following a noise change in the stationary noise.

According to the present disclosure, the noise suppression gain of each band is decided and a noise suppressing process is performed in each channel. Based on the characteristics of framed signals of a plurality of channels, it is determined whether each band is stationary noise or non-stationary noise. For example, when each band is sequentially set as a determination band, it is determined whether the determination band is of stationary noise or non-stationary noise in respective channels, and the band is determined to be stationary noise when the determination band is determined to be stationary noise in all of the channels, and is determined to be non-stationary noise when the determination band is determined to be non-stationary noise in all of the channels. When the noise suppression gain of each band is decided for each frame in each of the channels, the determination result of the noise determination unit is commonly used.

In this way, according to the present disclosure, the occurrence of an unintended amplitude error in noise suppression gains of a plurality of channels caused by an estimation error of the band power of noise in a plurality of channels (for example, the right and left channels of a stereo signal) can be suppressed, and the collapse of orientation caused by inconsistency of the plurality of channels can be avoided.

According to the present disclosure, it is possible to realize effective noise suppression not only for stationary noise but also for non-stationary noise.

### BRIEF DESCRIPTION OF THE DRAWINGS

FIG. 1 is a diagram showing basic methods for reducing noise according to an embodiment of the present disclosure;

FIG. 2 is a diagram for describing an effect of noise reduction in a frame in which only noise is present;

FIG. 3 is a diagram for describing another effect of noise reduction in a frame in which noise and a voice are mixed;

FIG. 4 is a block diagram showing a configuration example of a noise suppressing device as a first embodiment of the present disclosure;

FIG. 5 is a diagram for describing a calculating operation in a zero-crossing width calculation unit of a voiced sound detection unit;

FIG. 6 is a diagram showing an example of a signal waveform (amplitude of each sample) and a histogram of a zero-crossing width when a framed signal is a voice (non-noise);

FIG. 7 is a diagram showing an example of a signal waveform (amplitude of each sample) and a histogram of a zero-crossing width when a framed signal is a voice (noise);

FIG. 8 is a flowchart describing an example of a determination process executed by a voiced band determination unit;

FIG. 9 is a flowchart describing an example of a process for obtaining a noise template BN (rmin,b) executed by a non-stationary noise determination unit;

FIG. 10 is a flowchart for describing an example of an output process of a non-stationary noise flag Fnsn(u) executed by the non-stationary noise determination unit;

FIG. 11 is a flowchart for describing the procedure of a determination process of a noise/non-noise determination unit;

FIG. 12 is a diagram showing a development example of a weight coefficient α (u,b) computed in an α computation unit;

FIG. 13 is a block diagram showing a configuration example of a noise suppressing device as a second embodiment of the present disclosure;

FIG. 14 is a block diagram showing a configuration example of a noise suppression gain generation unit included in the noise suppressing device;

FIG. 15 is a flowchart for describing the procedure of a determination process by a noise/non-noise determination unit; and

FIG. 16 is a diagram showing a configuration example of a computer which executes a noise suppressing process using software.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments (hereinafter, referred to as “embodiments”) of the present disclosure will be described. Description will be provided in the following order.

1. First Embodiment

2. Second Embodiment

3. Modification Example

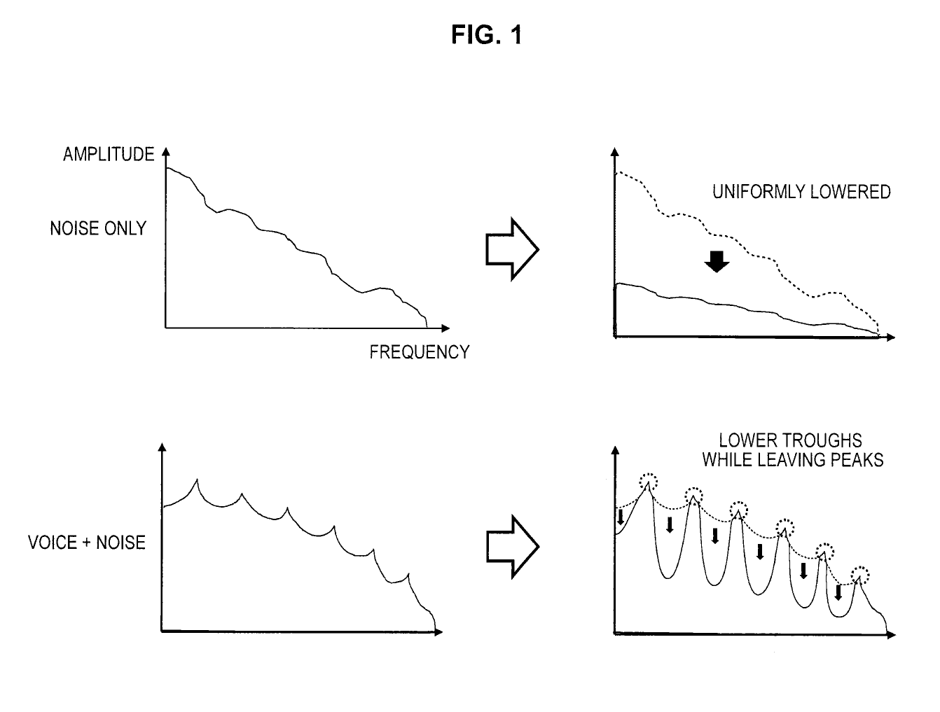

FIG. 1 shows basic measures for reducing noise according to an embodiment of the present disclosure. The effect of noise reduction is obtained for a frame in which only noise is included by uniformly lowering the amplitude over bands. On the other hand, the effect of noise reduction is obtained for a frame in which a voice and noise are mixed by maintaining the peaks of a spectrum resulting from the voice and lowering (slashing) the level of troughs.

In addition, in the present disclosure, an estimation unit of estimating band power of non-stationary noise is added to the framework of spectral subtraction in which stationary noise is suppressed. Since signals of the non-stationary noise change faster than those of stationary noise, using the same method as that of stationary noise makes it difficult to follow a change in noise when an estimation value is updated. Thus, it is determined whether noise of the corresponding frame is stationary noise or non-stationary noise, and when it is non-stationary noise, following performance on noise is improved by accelerating the speed of following the noise.

Estimation of band power of non-stationary noise is performed in such a way that noise or non-noise is determined by monitoring the state of a signal in each frame for each band, and estimation values of noise are sequentially updated in a frame determined to include noise, in the same manner as stationary noise.

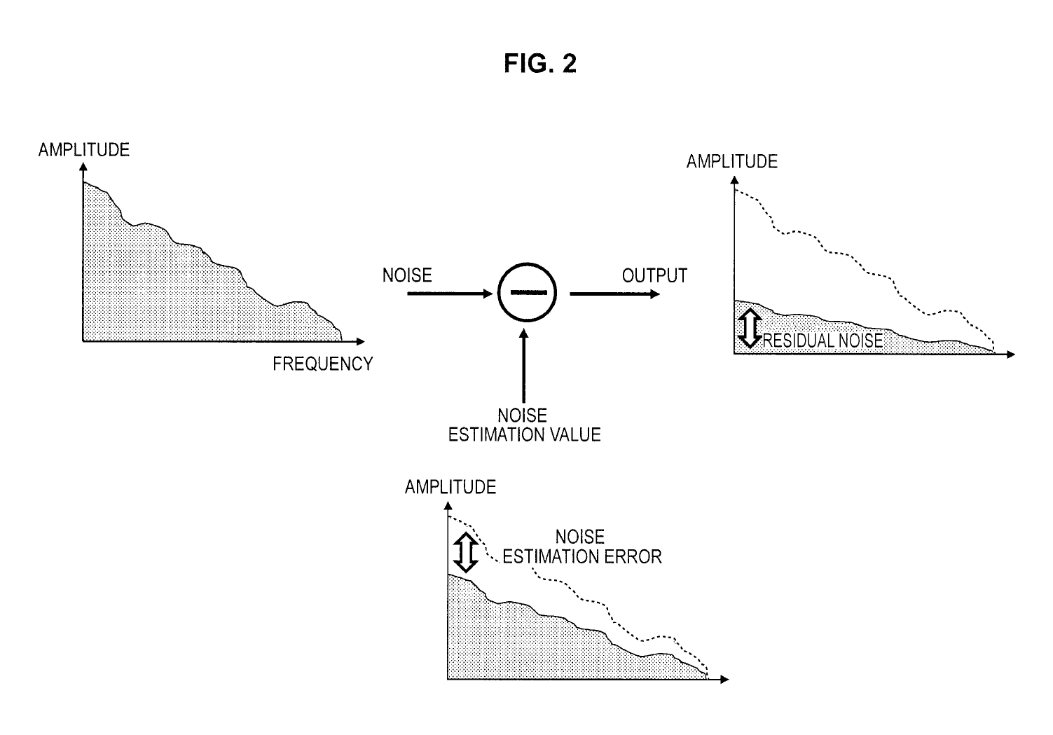

For a frame in which only noise is present, the effect of noise reduction is obtained by subtracting a noise estimation value in the entire band from noise, as shown in FIG. 2. However, in the case of non-stationary noise, a noise estimation error becomes great as an amplitude change of noise is difficult to follow using the same following speed as that of stationary noise, which is attributable to the result of increasing residual noise of an output. For this reason, the following speed of noise estimation increases.

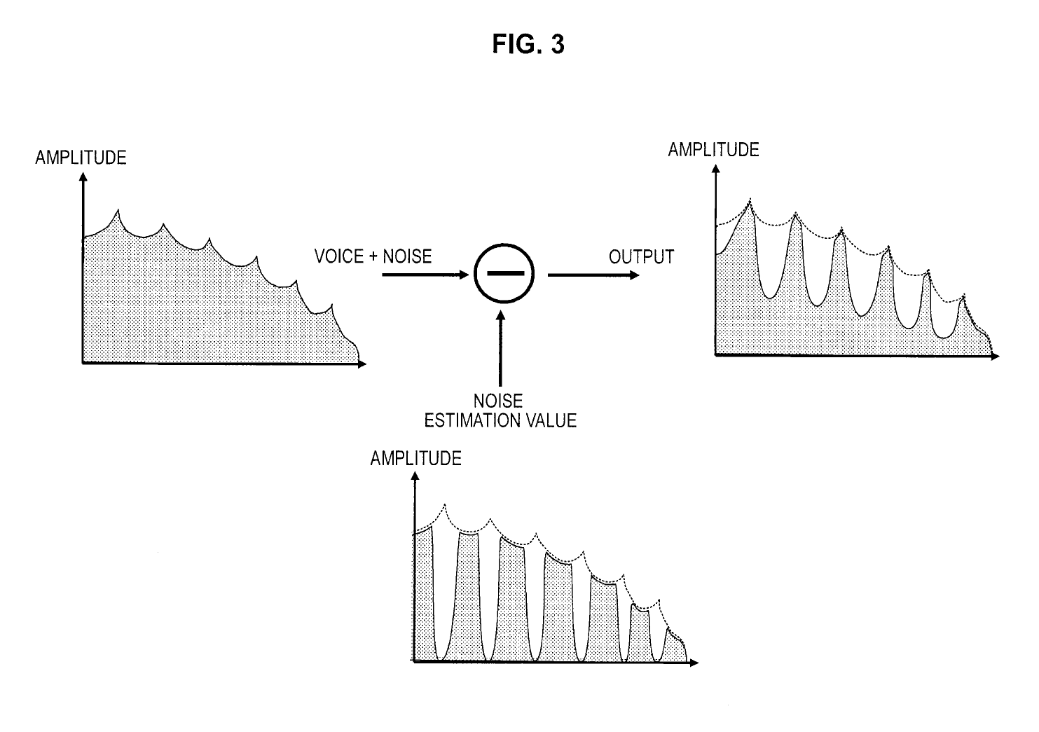

On the other hand, in a frame in which noise and a voice are mixed, because it is difficult to separate noise from the voice on a non-stationary spectrum, the peaks of the spectrum are assumed to result from a voice signal and portions other than the peaks of the spectrum, in other words, the portions of the troughs, are suppressed, in order to obtain the effect of noise suppression, as shown in FIG. 3. In order to realize this, updating noise estimation values for the portions other than the peaks, i.e., the troughs, after the peaks of the spectrum are detected has been suggested.

Also in this case, the following speed of noise estimation for non-stationary noise increases.

Herein, when the peaks of the spectrum are detected, there is a risk of detecting a false peak when only the peaks are detected. For this reason, the accuracy of estimating noise can be enhanced by more reliably catching peaks resulting from a voice, such as checking whether the intervals of the peaks on the frequency axis are uniform.

### 1. First Embodiment

### Configuration of a Noise Suppressing Device

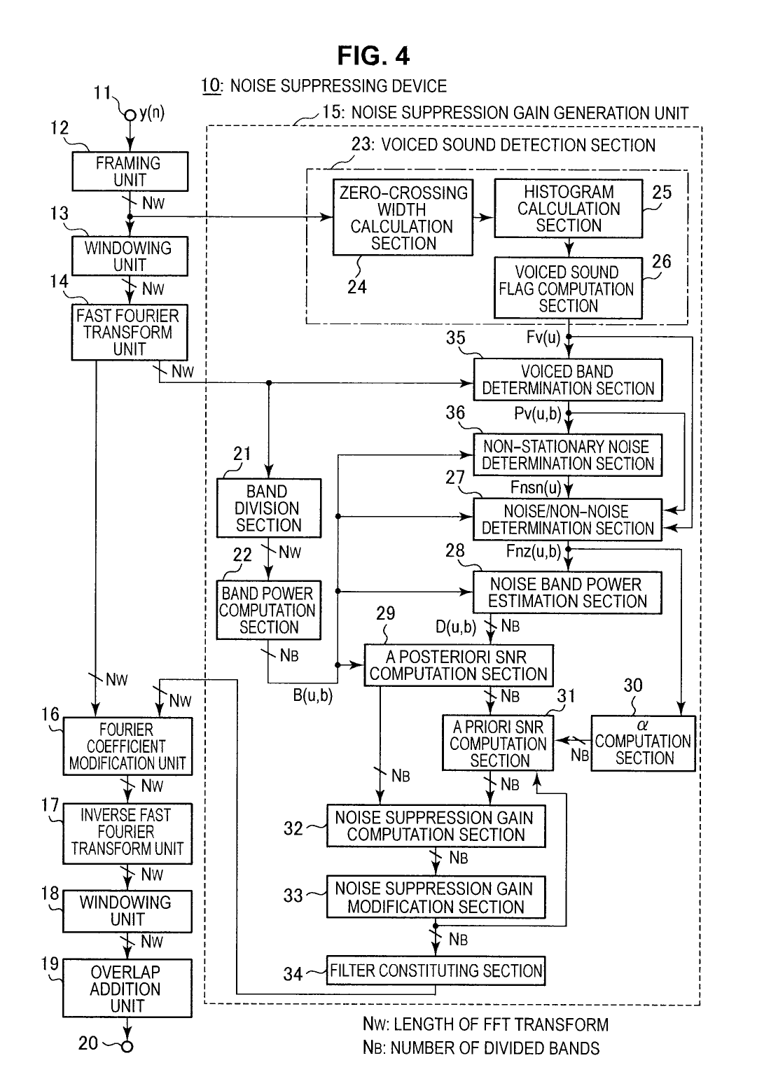

FIG. 4 shows a configuration example of a noise suppressing device 10 as a first embodiment of the present disclosure. This noise suppressing device 10 has a signal input terminal 11, a framing unit 12, a windowing unit 13, a fast Fourier transform unit 14, and a noise suppression gain generation unit 15. Further, this noise suppressing device 10 has a Fourier coefficient modification unit 16, an inverse fast Fourier transform unit 17, a windowing unit 18, an overlap addition unit 19, and a signal output terminal 20.

The signal input terminal 11 is a terminal which supplies an input signal y(n). This input signal y(n) is a digital signal having a sampling frequency of fs. The framing unit 12 frames the input signal y(n) supplied to the signal input terminal 11 by dividing the input signal into frames having a predetermined frame length, for example, a frame length of Nf sample in order to perform a process for each frame. For example, an n^{th} sample of the signal of a u^{th} frame is indicated by yf(u,n). In a framing process of the framing unit 12, an adjacent frame may be overlapped.

The windowing unit 13 performs windowing on a framed signal yf(u,n) using an analysis window wana(n). The windowing unit 13 uses, for example, the definition provided in the following formula (1) as the analysis window wana(n). Nw is a window length.

$$\begin{matrix}[ Math . 1 ] & \\ {w}_{ana} ( n ) = \sqrt{0.5 - 0.5 * cos ( \frac{2 π n}{{N}_{w}} )} & ( 1 )\end{matrix}$$

The fast Fourier transform unit 14 implements a fast Fourier transform (FFT) process for the framed signal yf(u,n) that has been windowed in the windowing unit 13 so as to convert time domain signals into frequency domain signals. The noise suppression gain generation unit 15 generates a noise suppression gain corresponding to each Fourier coefficient based on the framed signal yf(u,n) obtained in the framing process and each Fourier coefficient (each frequency spectrum) obtained in the fast Fourier transform process. The noise suppression gain corresponding to each Fourier coefficient constitutes a filter on the frequency axis. Details of the noise suppression gain generation unit 15 will be described later.

The Fourier coefficient modification unit 16 performs coefficient modification by taking the product of each Fourier coefficient obtained in the fast Fourier transform process and the noise suppression gain corresponding to each Fourier coefficient generated in the noise suppression gain generation unit 15. In other words, the Fourier coefficient modification unit 16 performs filter calculation to suppress noise on the frequency axis.

The inverse fast Fourier transform unit 17 implements an inverse fast Fourier transform (IFFT) for each Fourier coefficient that has undergone coefficient modification. This inverse fast Fourier transform unit 17 performs an inverse process to that of the above-described fast Fourier transform unit 14 so as to convert frequency domain signals into time domain signals.

The windowing unit 18 performs windowing on the framed signal obtained in the inverse fast Fourier transform unit 17, whose noise is suppressed using a synthesis window wsyn(n). The windowing unit 18 uses, for example, the definition in the following formula (2) as the synthesis window wsyn(n).

$$\begin{matrix}[ Math . 2 ] & \\ {w}_{syn} ( n ) = \sqrt{0.5 - 0.5 * cos ( \frac{2 π n}{{N}_{w}} )} & ( 2 )\end{matrix}$$

Note that the shapes of the analysis window wana(n) in the windowing unit 13 and the synthesis window wsyn(n) in the windowing unit 18 may be arbitrary. However, it is desirable to use a shape that satisfies a perfect reconstruction condition in a series of analysis and synthesis systems.

The overlap addition unit 19 performs overlapping on a frame boundary portion of the framed signal of each frame that has undergone windowing in the windowing unit 18 to obtain an output signal whose noise is suppressed. The signal output terminal 20 outputs an output signal obtained in the overlap addition unit 19.

An operation of the noise suppressing device 10 will be briefly described. The input signal y(n) is supplied to the signal input terminal 11 and then to the framing unit 12. In order to perform a process for each frame, the input signal y(n) is framed in the framing unit 12. In other words, in the framing unit 12, the input signal y(n) is divided into frames having a predetermined frame length, for example, a frame length of an Nf sample. Framed signals yf(u,n) of each frame are sequentially supplied to the windowing unit 13.

In the windowing unit 13, windowing is performed on the framed signals yf(u,n) using the analysis window wana(n) in order to obtain a Fourier coefficient to be described later which is stable in the fast Fourier transform unit 14 to be described later. The framed signals yf(u,n) that have undergone windowing as described above are supplied to the fast Fourier transform unit 14. In the fast Fourier transform unit 14, a fast Fourier transform process is performed on the framed signals yf(u,n) that have been windowed so as to convert time domain signals into frequency domain signals. Each Fourier coefficient (each frequency spectrum) obtained in the fast Fourier transform process is supplied to the Fourier coefficient modification unit 16.

The framed signals yf(u,n) of each frame obtained in the framing unit 12 are supplied to the noise suppression gain generation unit 15. In addition, each Fourier coefficient of each frame obtained in the fast Fourier transform unit 14 is supplied to the noise suppression gain generation unit 15. In the noise suppression gain generation unit 15, a noise suppression gain corresponding to each Fourier coefficient is generated for each frame based on each framed signal yf(u,n) and Fourier coefficient. The noise suppression gain corresponding to each Fourier coefficient is supplied to the Fourier coefficient modification unit 16.

In the Fourier coefficient modification unit 16, coefficient correction is performed by taking the product of each Fourier coefficient obtained by performing the fast Fourier transform process for each frame in the fast Fourier transform unit 14 and the noise suppression gain corresponding to each Fourier coefficient generated in the noise suppression gain generation unit 15. In other words, in the Fourier coefficient modification unit 16, filter calculation for suppressing noise is performed on the frequency axis. Each Fourier coefficient that has undergone coefficient modification is supplied to the inverse fast Fourier transform unit 17.

In the inverse fast Fourier transform unit 17, an inverse fast Fourier transform process is implemented for each Fourier coefficient in which a coefficient has been modified for each frame so as to convert frequency domain signals into time domain signals. Framed signals obtained in the inverse fast Fourier transform unit 17 are supplied to the windowing unit 18. In this windowing unit 18, windowing is performed on the framed signals obtained in the inverse fast Fourier transform unit 17, whose noise is suppressed, using the analysis window wsyn(n) for each frame.

The framed signals of each frame that has undergone windowing in the windowing unit 18 are supplied to the overlap addition unit 19. In this overlap addition unit 19, overlapping is performed on the frame boundary portion of the framed signals of each frame to obtain an output signal whose noise is suppressed.

Then, the output signal is output to the signal output terminal 20.

[Noise Suppression Gain Generation Unit]

Details of the noise suppression gain generation unit 15 will be described. This noise suppression gain generation unit 15 generates a noise suppression gain basically using the noise suppressing technology disclosed in “Speech Enhancement

Using a Minimum Mean Square Error Short-Time Spectral Amplitude Estimator” described above. First, the overview of the noise suppressing technology will be described below.

In the noise suppressing technology, when an input band signal in the uth frame and the b^{th} band is set to Y(u,b), a noise suppression gain G(u,b) is used to obtain a band signal X(u,b) whose noise is suppressed, as shown in the following formula (3). The noise suppression gain G(u,b) is calculated using an a priori SNR “ζ(u,b)” and an a posteriori SNR “γ(u,b)”.

X(u,b)=G(u,b)Y(u,b) (3)

The a posteriori SNR “γ(u,b)” is calculated using the following formula (4) when the band power of the input signal is set to B(u,b) and the estimation band power of noise is set to D(u,b).

γ(u,b)=B(u,b)/D(u,b) (4))

The a priori SNR “ζ(u,b)” is calculated using the following formula (5) using a weight coefficient (smoothing coefficient) α. Herein, P[] is an operator defined as in the following formula (6).

ζ(u,b)=αG²(u−1,b)γ(u−1,b)+(1−α)P[γ(u,b)−1] (5)

$$\begin{matrix}[ Math . 3 ] & \\ P [ x ] = \{ \begin{matrix}x & if x \leq 0 \\ 0 & otherwise\end{matrix} & ( 6 )\end{matrix}$$

The noise suppression gain G(u,b) is calculated as in the following formula (7) using the a priori SNR “ζ(u,b)” and the a posteriori SNR “γ(u,b)”. In(x) is a modified Bessel function of the first kind.

$$\begin{matrix} [ Math . 4 ] & \\ G ( u , b ) = \frac{\sqrt{π}}{2} \frac{\sqrt{v ( u , b )}}{γ ( u , b )} exp ( - \frac{v ( u , b )}{2} ) [ ( 1 + v ( u , b ) ) {I}_{0} ( \frac{v ( u , b )}{2} ) + v ( u , b ) {I}_{1} ( \frac{v ( u , b )}{2} ) ] \\ [ where v ( u , b ) = \frac{ξ ( u , b )}{1 + ξ ( u , b )} γ ( u , b ) ] & ( 7 )\end{matrix}$$

Since a noise suppression gain is calculated from estimated values of the a priori SNR and the ε where ri SNR, the estimation accuracy directly influences the adequacy of noise suppression. Above all, since an estimation value of the band power of noise, which is D(u,b), influences all of the estimated values of SNRs, the improvement of the estimation accuracy is an important task in targeting the improvement of performance of an overall device.

Also when it is assumed that there is no estimation error in the band power of noise, it is recommended in “Speech Enhancement Using a Minimum Mean Square Error Short-Time Spectral Amplitude Estimator” to use a fixed value of α=0.98 in the calculation method of the above-described a priori SNR (refer to formula (5)) so that estimation is difficult to follow a fast change of signals. As a result, an estimation error occurs in the noise suppression gain G(u,b), which is attributable to deterioration of sound quality such as causing the start of a voice to be distorted. On the other hand, when a small value is used for a to increase the following speed, there is a problem in that an adverse effect of acoustically offensive noise that is called musical noise arises, and the quality of sound deteriorates.

The noise suppression gain generation unit 15 basically uses the noise suppression technology disclosed in “Speech Enhancement Using a Minimum Mean Square Error Short-Time Spectral Amplitude Estimator” described above. However, by estimating the band power of noise with high accuracy and adaptively changing a coefficient in accordance with the state of a signal, an optimum noise suppression gain G(u,b) can be obtained.

The noise suppression gain generation unit 15 has a band division section 21, a band power computation section 22, a voiced sound detection section 23, a voiced band determination section 35, a non-stationary noise determination section 36, a noise/non-noise determination section 27, and a noise band power estimation section 28. In addition, the noise suppression gain generation unit 15 has an a posteriori SNR computation section 29, an a computation section 30, an a priori SNR computation section 31, a noise suppression gain computation section 32, a noise suppression gain modification section 33, and a filter constituting section 34.

The band division section 21 divides each frequency spectrum (each Fourier coefficient) obtained in the fast Fourier transform process in the fast Fourier transform unit 14 into a predetermined number Nb of frequency bands, for example, 25 frequency bands. Table 1 shows an example of band division. Each band number is a number given to identify each band. Each frequency band is based on a notion from research of auditory psychology that the sensory resolution of the human auditory system further deteriorates in higher frequencies.

TABLE 1

| BAND NUMBER | FREQUENCY RANGE | |
|---|---|---|
| 0 | 0~125 | Hz |
| 1 | 125~250 | Hz |
| 2 | 250~375 | Hz |
| 3 | 376~563 | Hz |
| 4 | 563~750 | Hz |
| 5 | 750~938 | Hz |
| 6 | 938~1125 | Hz |
| 7 | 1125~1313 | Hz |
| 8 | 1313~1563 | Hz |
| 9 | 1563~1813 | Hz |
| 10 | 1813~2063 | Hz |
| 11 | 2063~2313 | Hz |
| 12 | 2313~2563 | Hz |
| 13 | 2563~2813 | Hz |
| 14 | 2813~3063 | Hz |
| 15 | 3063~3375 | Hz |
| 16 | 3375~3688 | Hz |
| 17 | 3688~4370 | Hz |
| 18 | 4370~5235 | Hz |
| 19 | 5235~6375 | Hz |
| 20 | 6375~7658 | Hz |
| 21 | 7658~9354 | Hz |
| 22 | 9354~11775 | Hz |
| 23 | 11775~15513 | Hz |
| 24 | 15513~22050 | Hz |

The band power computation section 22 computes the band power B(u,b) from a frequency spectrum for each band divided in the band division section 21. Herein, (u,b) indicates the u^{th} frame and the b^{th} band. The band power computation section 22 uses, as a method of computing the band power B(u,b), a method in which each power spectrum is computed from each frequency spectrum, the maximum value is obtained within the frequency range, and the maximum value is set to B(u,b) as a representative value. Note that the band power computation section 22 may also use, as another method of computing the band power B(u,b), a method in which each power spectrum is computed from each frequency spectrum, the average value within the frequency range is obtained, and the average value is set to B(u,b) as a representative value.

The voiced sound detection section 23 outputs a voiced sound flag Fv(u) indicating whether a voiced sound is included for each frame based on the framed signal yf(u,n) obtained in the framing unit 12. This voiced sound detection section 23 has a zero-crossing width calculation section 24, a histogram calculation section 25, and a voiced sound flag computation section 26.

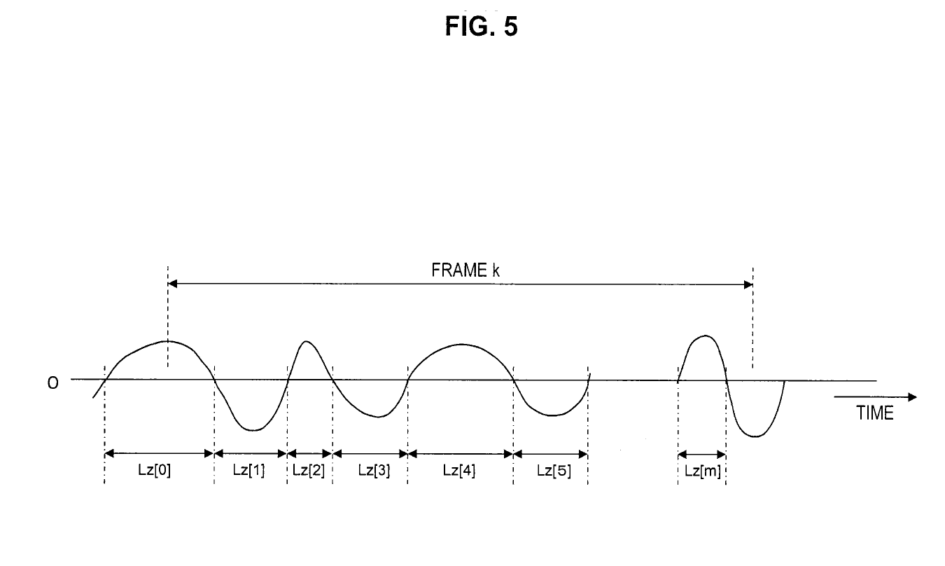

The zero-crossing width calculation section 24 detects a point at which the sign of successive samples that are framed is reversed, for example, from positive to negative or from negative to positive, or a point at which there is a sample having the value of 0 between samples having reversed signs as a zero-crossing point. In addition, the zero-crossing width calculation section 24 calculates the number of samples between adjacent zero-crossing points and records the samples as zero-crossing widths of Lz(0), Lz(1), . . . , Lz(m) as shown in FIG. 5.

The histogram calculation section 25 receives a zero-crossing width Lz(p) from the zero-crossing width calculation section 24 and examines distribution within a frame. When statistics are given in 20 domains for every 10 samples, for example, the histogram calculation section 25 sets Hz(q)=0 (0≦q<20) as the initial value. Then, the histogram calculation section 25 obtains a histogram Hz(q) as in the following formula (8).

$$\begin{matrix}[ Math . 5 ] & \\ \{ \begin{matrix}{H}_{z} ( q ) = {H}_{z} ( q ) + 1 & if q < 19 , q * 10 \leq {L}_{z} ( p ) < ( q + 1 ) * 10 \\ {H}_{z} ( 19 ) = {H}_{z} ( 19 ) + 1 & otherwise\end{matrix} & ( 8 )\end{matrix}$$

The voiced sound flag computation section 26 obtains an index (class) q peak in which the frequency Hz(q) obtained in the histogram calculation section 25 is set as the maximum value. Then, the voiced sound flag computation section 26 compares the frequency Hz(q) of the index q peak to the threshold value Th(q) of the index q peak, and sets a voiced sound flag Fv(u) as shown in the following formula (9). Herein, each index indicates the range of each zero-crossing width.

$$\begin{matrix}[ Math . 6 ] & \\ {F}_{v} ( k ) = \{ \begin{matrix}1 & if {H}_{z} ( {q}_{peak} ) > {T}_{h} ( {q}_{peak} ) \\ 0 & otherwise\end{matrix} & ( 9 )\end{matrix}$$

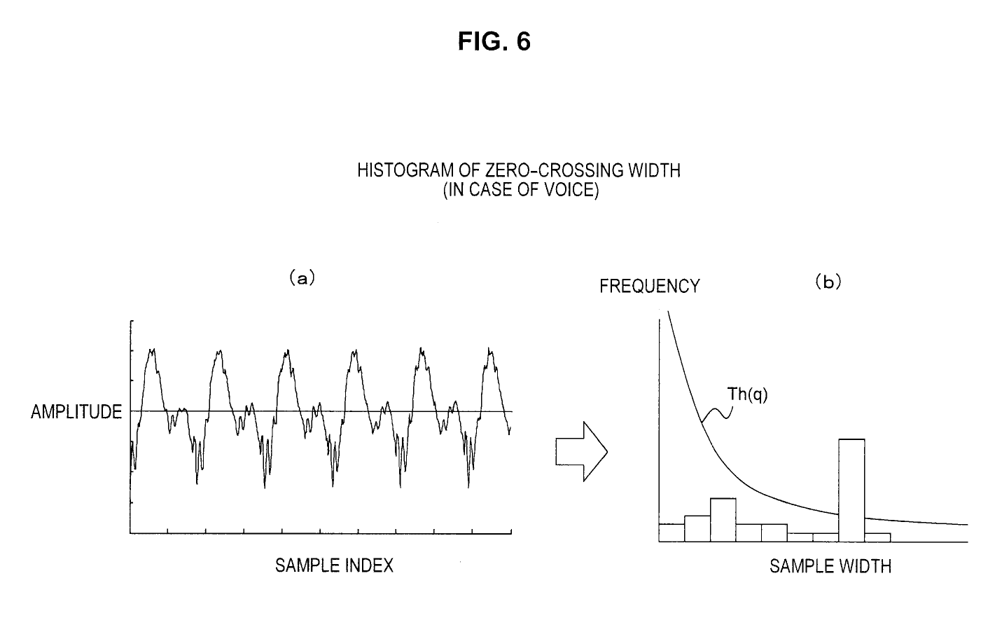

(a) and (b) of FIG. 6 show an example of a signal waveform (the amplitude of each sample) and a histogram of a zero-crossing width when the framed signal yf(u,n) is a voice (non-noise). In the case of a voice (non-noise), the same waveform is repeated, and the frequency of a predetermined zero-crossing width range increases. For this reason, Hz(q)>Th(q), and the voiced sound flag Fv(u) is set to Fv(u)=1. Herein, the threshold value Th(q) is set for each zero-crossing width range (index), and to have a value as great as Th(q) corresponding to a zero-crossing width range in which the zero-crossing width is narrow.

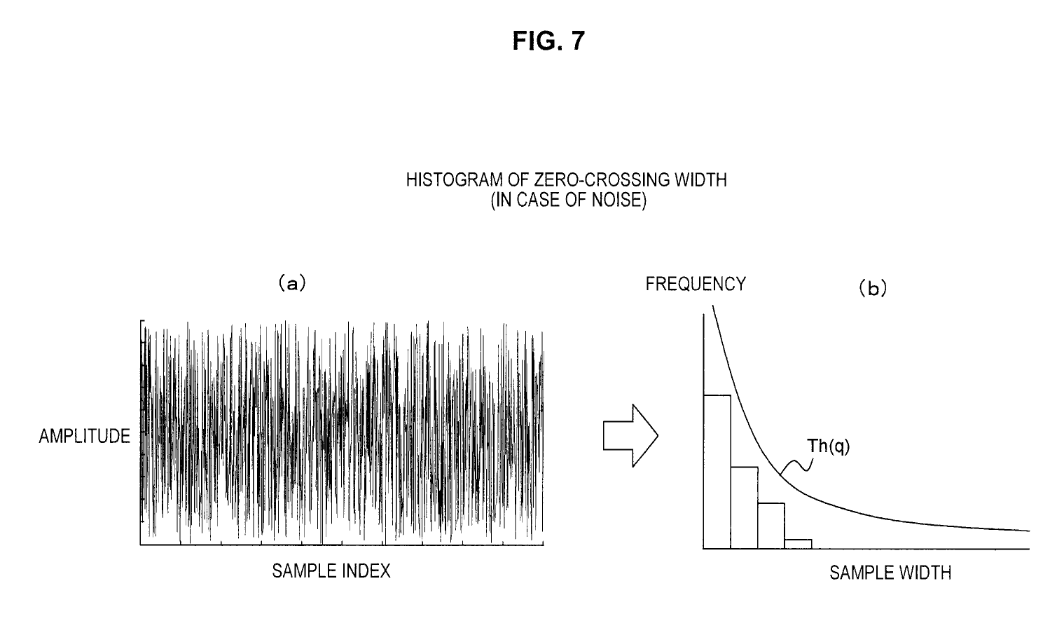

On the other hand, (a) and (b) of FIG. 7 show an example of a signal waveform (the amplitude of each sample) and a histogram of a zero-crossing width when the framed signal yf(u,n) is noise. In the case of noise, the frequency of a zero-crossing width range in which the zero-crossing width is narrow increases. For this reason, Hz(q)≦Th(q), and the voiced sound flag Fv(u) is set to Fv(u)=0.

The voiced band determination section 35 sets a voiced band flag Pv(u,b) of each band using the voiced sound flag Fv(u) obtained in the voiced sound detection section 23 and each frequency spectrum (each Fourier coefficient) obtained from the fast Fourier transform process in the fast Fourier transform unit 14 for each band. The voiced band determination section 35 examines the amplitude of an input Fourier coefficient Y(u,k) of the u^{th} frame, ascertains whether there is a peak of a histogram resulting from a voice within a band for each band, and sets the voiced band flag Pv(u,b) as shown in the following formula (10).

$$\begin{matrix} [ Math . 7 ] & \\ Pv ( u , b ) = \{ \begin{matrix}1 & when a peak resulting from a voice is present within a band \\ 0 & otherwise\end{matrix} & ( 10 )\end{matrix}$$

Whether a peak resulting from a voice is present can be determined based on, for example, conditions (1) and (2) below.

(1) The voiced sound flag Fv(u) is set.

(2) The value at the maximum point of the amplitude of a Fourier coefficient is greater than or equal to Mt (Mt is the threshold value) times the average value within the band.

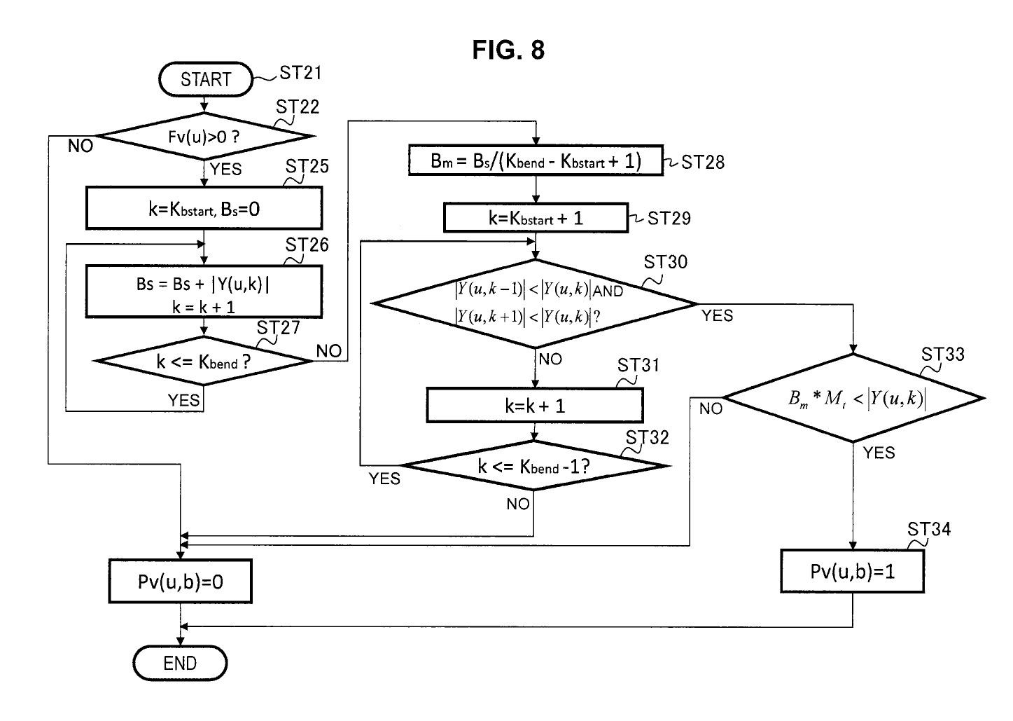

The voiced band determination section 35 executes the determination process described in the flowchart of FIG. 8 in each band for each frame. The voiced band determination section 35 starts the process in Step ST21, and then moves to the process of Step ST22. In Step ST22, the voiced band determination section 35 determines whether the voiced sound flag Fv(u) is greater than 0, in other words, whether the voiced sound flag Fv(u) is set.

When Fv(u)>0 is not satisfied, or the voiced sound flag Fv(u) is not set, the voiced band determination section 35 proceeds to the process of Step ST23, sets Pv(u,b)=0, and finishes the process in Step ST24. On the other hand, when Fv(u)>0 is satisfied, or the voiced sound flag Fv(u) is set, the voiced band determination section 35 moves to a process for determining whether a peak resulting from a voice is present.

The voiced band determination section 35 initializes by setting k=Kbstart, and Bs=0 in Step ST25. Herein, “Kbstart” is the first number of Fourier coefficients within the band and “Kbend” is the last number of the Fourier coefficients within the band. Next, the voiced band determination section 35 performs an arithmetic operation of Bs=Bs+|Y(u,k)| and increases the value of k by one in Step ST26. Then, the voiced band determination section 35 determines whether k is smaller than Kbend in Step ST27. When k is smaller than Kbend, the voiced band determination section 35 returns to Step ST26, repeats the same process as described above, and obtains the sum of absolute values of Fourier coefficients Y(u,k) within the band. When k is equal to Kbend, the voiced band determination section 35 moves to the process of Step ST28.

In Step ST28, the voiced band determination section 35 performs an arithmetic operation of Bm=Bs/(Kbend−Kbstart+1) to obtain the average value within the band Bm. Next, the voiced band determination section 35 sets k=Kbstart+1 in Step ST29. Then, the voiced band determination section 35 determines whether the Fourier coefficient Y(u,k) is at the maximum point in Step ST30. In other words, the voiced band determination section 35 determines whether the condition for the maximum point of |Y(u,k−1)|<|Y(u,k)| or |Y(u,k+1)|<|Y(u,k)| is satisfied.

When the condition for the maximum point is not satisfied, the voiced band determination section 35 increases k by one in Step ST31. Then, the voiced band determination section 35 determines whether k is smaller than Kbend−1 in Step ST32. When k is equal to or smaller than Kbend−1, the voiced band determination section 35 returns to Step ST30, and determines whether a next Fourier coefficient Y(u,k) is at the maximum point. When k is greater than Kbend−1 in Step ST32, in other words, when the maximum point is not within the band, the voiced band determination section 35 proceeds to the process of Step ST23, sets Pv(u,b)=0, and finishes the process in Step ST24.

When the k^{th} Fourier coefficient Y(u,k) satisfies the condition for the maximum point in Step ST30, the voiced band determination section 35 moves to the process of Step ST33. In Step ST33, the voiced band determination section 35 determines whether the value of the maximum point is greater than or equal to Mt times the average value within the band Bm. In other words, the voiced band determination section 35 determines whether the condition of Bm*Mt<|Y(u,k)| is satisfied.

When the condition is not satisfied, the voiced band determination section 35 proceeds to the process of Step ST23, sets Pv(u,b)=0, and finishes the process in Step ST24. On the other hand, when the condition is satisfied, the voiced band determination section 35 proceeds to the process of Step ST34, sets Pv(u,b)=1, and finishes the process in Step ST24.

Returning to FIG. 4, the non-stationary noise determination section 36 determines whether the signal of the band for which it is determined that Pv(u,b)=0 in the voiced band determination section 35 has characteristics of non-stationary noise. In other words, the non-stationary noise determination section 36 outputs a non-stationary noise flag Fnsn(u) for each frame using the voiced band flag Pv(u,b) obtained in the voiced band determination section 35 and the band power B(u,b) computed in the band power computation section 22.

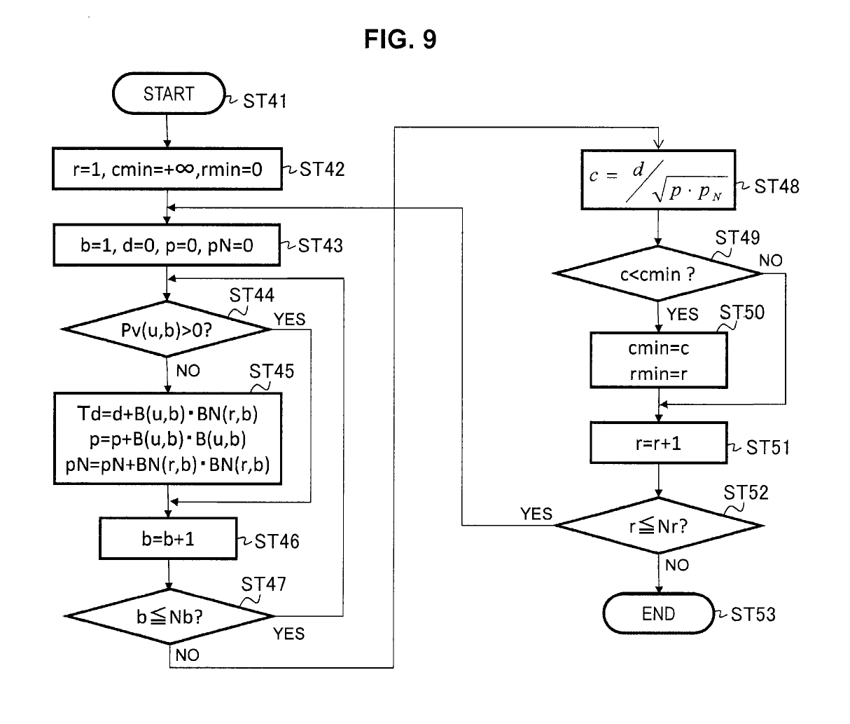

The non-stationary noise determination section 36 first searches for a noise template BN(r,b) corresponding to target noise with regard to the band power B(u,b) of a current frame in the range of (1≦r≦Nr) to obtain the closest noise template BN(rmin,b). The flowchart of FIG. 9 describes an example of a process of obtaining the noise template BN(rmin,b).

The non-stationary noise determination section 36 starts the process in Step ST41, and then moves to the process of Step ST42. In Step ST42, the non-stationary noise determination section 36 sets r=1, cmin=+∞, and rmin=0. In addition, the non-stationary noise determination section 36 sets b=1, d=0, p=0, and pN=0 in Step ST43.

Next, the non-stationary noise determination section 36 determines whether the voiced band flag Pv(u,b) is greater than 0, in other words, whether the voiced band flag Pv(u,b) is set in Step ST44. When Pv(u,b)>0 is not satisfied, or the voiced band flag Pv(u,b) is not set, the non-stationary noise determination section 36 moves to the process of Step ST45. In Step ST45, the non-stationary noise determination section 36 performs arithmetic operations of d=d+B(u,b)·BN(r,b), p=p+B(u,b)·B(u,b), and pN=pN+Bn(r,b)·BN(r,b).

After the process of Step ST45, the non-stationary noise determination section 36 moves to the process of Step ST46. Also when Pv(u,b)>0 is satisfied or the voiced band flag Pv(u,b) is set in Step ST44 described above, the non-stationary noise determination section 36 moves to the process of Step ST46. In Step ST46, the non-stationary noise determination section 36 increases b by one.

Next, the non-stationary noise determination section 36 determines whether b≦Nb in Step ST47. When b≦Nb is satisfied, the non-stationary noise determination section 36 returns to the process of Step ST44, and repeats the same process as described above. On the other hand, when b≦Nb is not satisfied, the non-stationary noise determination section 36 moves to the process of Step ST48. In Step ST48, the non-stationary noise determination section 36 performs an arithmetic operation of c=d/√(p·pN).

Next, the non-stationary noise determination section 36 determines whether c<cmin is satisfied in Step ST49. When c<cmin is satisfied, the non-stationary noise determination section 36 sets cmin=c, rmin=c, and rmin=r in Step ST50. Then, in Step ST51, r is increased by one. When c<cmin is not satisfied in Step ST49, the non-stationary noise determination section 36 immediately proceeds to Step ST51, and increases r by one.

Next, the non-stationary noise determination section 36 determines whether r≦Nr is satisfied in Step ST52. When r≦Nr is satisfied, the non-stationary noise determination section 36 returns to Step ST43, and repeats the same operation as described above. On the other hand, when r≦Nr is not satisfied, the non-stationary noise determination section 36 finishes the process in Step ST53.

From the process of the flowchart in FIG. 9 described above, the closest noise template BN(rmin, b) is obtained for the band power B(u,b).

Next, the non-stationary noise determination section 36 determines whether non-stationary noise is present in the corresponding frame. For the frames located ±S frames away from the current frame, a correlation l(u+s) of the template BN(rmin, b) obtained in the above description and the band power B(u+s,b) and a gain coefficient gN(u+s) are obtained (−S≦s≦S). Then, the non-stationary noise determination section 36 makes the determination based on conditions (1) and (2) below, and outputs a non-stationary noise flag Fnsn(u).

(1) The correlation 1(u+s) does not exceed IMAX.

(2) The variance of the gain coefficient gN(u+s) exceeds a threshold value GNT.

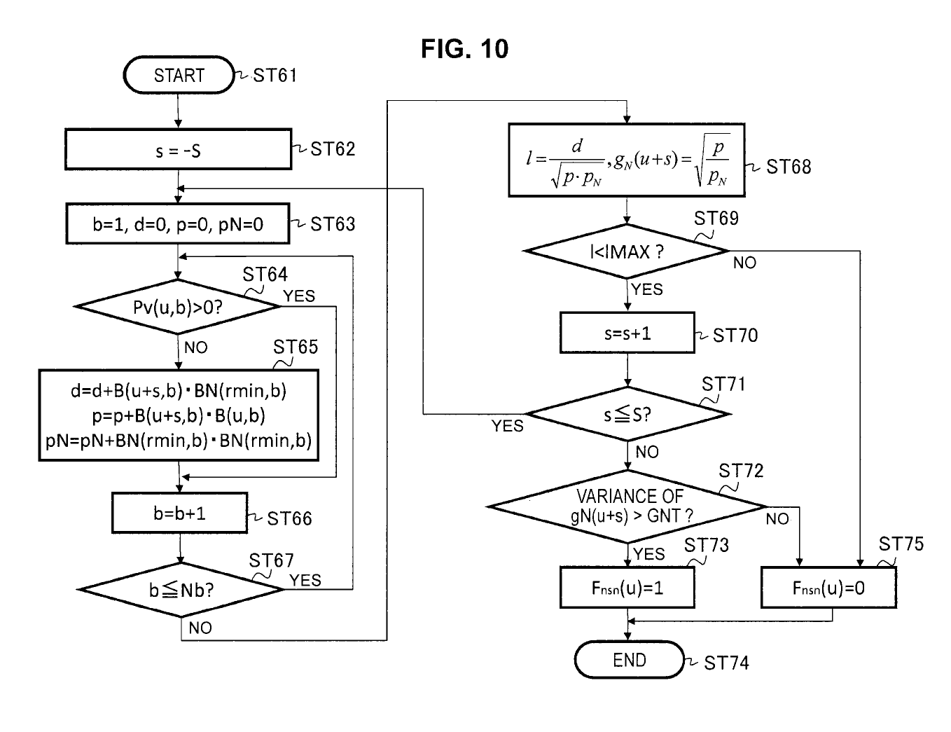

The flowchart of FIG. 10 describes an example of a process of outputting the non-stationary noise flag Fnsn(u). The non-stationary noise determination section 36 starts the process in Step ST61, and then moves to the process of Step ST62. In Step ST62, the non-stationary noise determination section 36 sets s=−S. In addition, the non-stationary noise determination section 36 sets b=1, d=0, p=0, and pN=0 in Step ST63.

Next, the non-stationary noise determination section 36 determines whether the voiced band flag Pv(u,b) is greater than 0, in other words, whether the voiced band flag Pv(u,b) is set in Step ST64. When Pv(u,b)>0 is not satisfied, or the voiced band flag Pv(u,b) is not set, the non-stationary noise determination section 36 moves to the process of Step ST65. In Step ST 65, the non-stationary noise determination section 36 performs arithmetic operations of d=d+B(u+s,b)·BN(rmin,b), p=p+B(u+s,b)·B(u,b), and pN=pN+BN(rmin,b)·BN(rmin,b).

After the process of Step ST65, the non-stationary noise determination section 36 moves to the process of Step ST66. Also when Pv(u,b)>0 is satisfied or the voiced band flag Pv(u,b) is set in Step ST64 described above, the non-stationary noise determination section 36 moves to the process of Step ST66. In Step ST66, the non-stationary noise determination section 36 increases b by one.

Next, the non-stationary noise determination section 36 determines whether b≦Nb is satisfied in Step ST67. When b≦Nb is satisfied, the non-stationary noise determination section 36 returns to the process of Step ST64, and repeats the same process as described above. On the other hand, when b≦Nb is not satisfied, the non-stationary noise determination section 36 moves to the process of Step ST68. In Step ST68, the non-stationary noise determination section 36 performs arithmetic operations of l=d/√(p·pN) and gN(u+s)=√(p·pN).

Next, the non-stationary noise determination section 36 determines whether 1<lMAX is satisfied in Step ST69. When 1<lMAX is satisfied, the non-stationary noise determination section 36 increases s by one in Step ST70. Then, the non-stationary noise determination section 36 determines whether s≦S is satisfied in Step ST71. When s≦S is satisfied, the non-stationary noise determination section 36 returns to Step ST63 and repeats the same operation as described above. On the other hand, when s≦S is not satisfied, the non-stationary noise determination section 36 moves to the process of Step ST72.

In Step ST72, the non-stationary noise determination section 36 determines whether the variance of the gain coefficient gN(u+s) exceeds the threshold value GNT. When the variance exceeds the threshold value GNT, the non-stationary noise determination section 36 sets Fnsn(u)=1 in Step ST73, and then finishes the process in Step ST74.

On the other hand, when the variance does not exceed the threshold value GNT in Step ST72, the non-stationary noise determination section 36 sets Fnsn(u)=0 in Step ST75, and then finishes the process in Step ST74. In addition, when 1<lMAX is not satisfied in Step ST69 described above, the non-stationary noise determination section 36 sets Fnsn(u)=0 in Step ST75, and then finishes the process in Step ST74.

From the process of the flowchart in FIG. 10 described above, the non-stationary noise flag Fnsn(u) indicating whether non-stationary noise is present in the u^{th} frame is set.

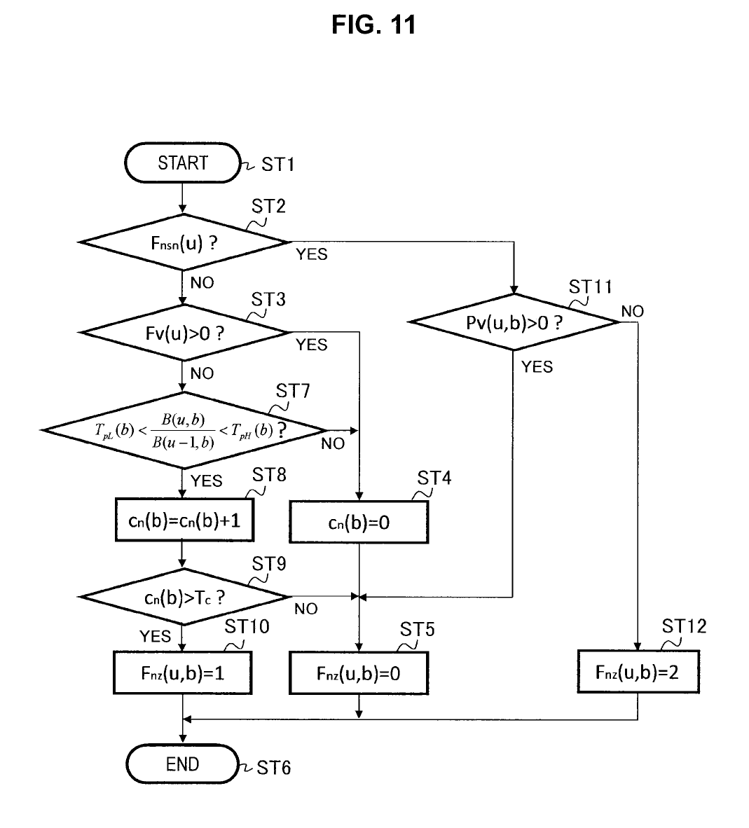

Returning to FIG. 4, the noise/non-noise determination section 27 sets a noise band flag Fnz(u,b) of each band for each frame. In this case, the noise/non-noise determination section 27 uses the voiced sound flag Fv(u) from the voiced sound detection section 23, the voiced band flag Pv(u,b) from the voiced band determination section 35, the non-stationary noise flag Fnsn(u) from the non-stationary noise determination section 36, and the band power B(u,b) from the band power computation section 22. The noise/non-noise determination section 27 executes the determination process shown in the flowchart of FIG. 11 for each frame in each band.

The noise/non-noise determination section 27 starts the determination process in Step ST1 to initialize the system. In the initialization, the noise/non-noise determination section 27 initializes a noise candidate frame continuous counter Cn(b) to be Cn(b)=0.

Next, the noise/non-noise determination section 27 moves to the process of Step ST2. In Step ST2, the noise/non-noise determination section 27 determines whether the non-stationary noise flag Fnsn(u) is greater than 0, in other words, whether Fnsn(u)=1 is satisfied. When Fnsn(u)=1 is not satisfied, the noise/non-noise determination section 27 moves to the process of Step ST3.

In Step ST3, the noise/non-noise determination section 27 determines whether or not the voiced sound flag Fv(u) is greater than 0, in other words, whether Fv(u)=1 is satisfied. When Fv(u)=1 is satisfied, in other words, when the current frame u is of a voiced sound, the noise/non-noise determination section 27 clears the noise candidate frame continuous counter Cn(b) so that Cn(b)=0 in Step ST4.

Then, the noise/non-noise determination section 27 determines that the current band b is not noise, and sets a noise band flag Fnz(u,b) so that Fnz(u,b)=0 in Step ST5, and then finishes the determination process in Step ST6.

When Fv(u)=0 in Step ST3, in other words, when the current frame u is not a voiced sound, the noise/non-noise determination section 27 moves to the process of Step ST7, and obtains the power ratio of the band power B(u,b) of the current frame u to the band power B(u−1,b) of the previous frame u−1 in Step ST7. Then, the noise/non-noise determination section 27 determines whether the power ratio falls within the range between the threshold value TpL(b) on the low level side and the threshold value TpH(b) on the high level side in Step ST7.

The noise/non-noise determination section 27 determines the current band b to be a candidate of noise when the power ratio falls within the range between the threshold values, and determines the current band b not to be noise when the power ratio does not fall within the range between the threshold values. This determination is made based on the assumption that the power of a noise signal is constant, and in contrast, that the power of a signal with a great change is not of noise.

When the power ratio does not fall within the range between the threshold values, in other words, when the current band b is determined not to be noise, the noise/non-noise determination section 27 clears the noise candidate frame continuous counter Cn(b) so that Cn(b)=0 in Step ST4. Then, the noise/non-noise determination section 27 sets Fnz(u,b)=0 in Step ST5, and then finishes the determination process in Step ST6.

On the other hand, when the power ratio falls within the range between the threshold values, in other words, when the current band b is determined to be a candidate of noise, the noise/non-noise determination section 27 moves to the process of Step ST8. In Step ST8, the noise/non-noise determination section 27 counts up the noise candidate frame continuous counter Cn(b) by one.

Then, the noise/non-noise determination section 27 determines whether the noise candidate frame continuous counter Cn(b) exceeds the threshold value Tc in Step ST9. When Cn(b)>Tc is not satisfied, the noise/non-noise determination section 27 determines that the current band b is not noise, sets Fnz(k,b)=0 in Step ST5, and then finishes the determination process in Step ST6.

On the other hand, when Cn(b)>Tc is satisfied, the noise/non-noise determination section 27 moves to the process of Step ST10. In Step ST10, the noise/non-noise determination section 27 determines that the current band b is noise (stationary noise), sets the noise band flag Fnz(u,b) so that Fnz(u,b)=1, and then finishes the determination process in Step ST6.

In addition, when Fnsn(u)=1 is satisfied in Step ST2, the noise/non-noise determination section 27 moves to the process of Step ST11. In Step ST11, the noise/non-noise determination section 27 determines whether the voiced band flag Pv(u,b) is greater than 0, in other words, whether Pv(u,b)=1 is satisfied.

When Pv(u,b)=1 is satisfied, the noise/non-noise determination section 27 determines that the current hand b is not noise, sets the noise band flag Fnz(u,b) so that Fnz(u,b)=0 in Step ST5, and then finishes the determination process in Step ST6. On the other hand, when Pv(u,b)=1 is not satisfied, the noise/non-noise determination section 27 determines that the current band b is noise (non-stationary noise), sets the noise band flag Fnz(u,b) so that Fnz(u,b)=2 in Step ST12, and then finishes the determination process in Step ST6.

With regard to determination of stationary noise in the determination process of the flowchart of FIG. 11 described above, one time of noise/non-noise determination is performed on all of the frames using the voiced sound flag Fv(u) obtained in the voiced sound detection section 23, and the combination of the determination and determination for each band is made to be the final determination result. This is because only determination made by monitoring the state of a signal of each band is sometimes insufficient. When noise is determined by detecting stationarity of band power, for example, particularly in a case in which the band width of a divided band is wide, it is difficult to discriminate a tone signal from noise. Thus, by performing the determination process of the flowchart of FIG. 11, the accuracy of noise determination of each band in determining stationary noise can improve.

Returning to FIG. 4, the noise band power estimation section 28 estimates a noise band power estimation value D(u,b) of each band for each frame. The noise band power estimation section 28 updates the noise band power estimation value D(u,b) only for the band of noise based on the noise band flag Fnz(u,b) set in the noise/non-noise determination section 27. In other words, the noise band power estimation section 28 updates the noise band power estimation value D(u,b) in a stationary noise band in which Fnz(u,b)=1 and a non-stationary noise band in which Fnz(u,b)=2.

As an example of the updating method of the noise band power estimation value D(u,b) in the noise band power estimation section 28, for example, an updating method using the band power B(u,b) and an index weight μnz as shown in the following formula (11) may be considered. In this case, the noise band power estimation section 28 obtains the estimated power of noise of the current frame by performing weighted addition on the band power of the current frame obtained in the band power computation section 22 and the band power of noise of the frame estimated in one frame before the current frame for each frame. In this case, the values of the index weight μnz of stationary noise and non-stationary noise are different.

$$\begin{matrix}[ Math . 8 ] & \\ D ( u , b ) = \{ \begin{matrix}{μ}_{nz 1} D ( u - 1 , b ) + ( 1 - {μ}_{nz 1} ) B ( u , b ) & if {F}_{nz} ( u , b ) == 1 ( in the case of stationary noise ) \\ {μ}_{nz 2} D ( u - 1 , b ) + ( 1 - {μ}_{nz 2} ) B ( u , b ) & if {F}_{nz} ( u , b ) == 2 ( in the case of non \text{-} stationary noise ) \\ D ( u - 1 , b ) & otherwise\end{matrix} & ( 11 )\end{matrix}$$

In the case of stationary noise, since the fluctuation of the amplitude of noise is low, it is possible to fully follow changes in noise even when the values of μnz are low. On the other hand, in the case of non-stationary noise, in a state in which the fluctuation of the amplitude of noise is high and a value of μnz is still high, it is not possible to follow the changes, and an estimation error of noise becomes severe, and thus it is not possible to sufficiently reduce noise, or an adverse effect thereof arises in the voice. For this reason, the index weight is switched according to the characteristics of noise. In other words, the weight of the band power of the current frame in non-stationary noise becomes greater than that of the band power of the current frame in stationary noise.

When Fnz(u,b)=1 in the case of stationary noise, it is set that μnz=μnz1. It is desirable to set μnz1 to be a value, for example, from about 0.9 to 1.0 to the extent that the noise band power estimation value D(u,b) follows actual changes in noise and auditory discomfort does not occur. In addition, when Fnz(u,b)=2 in the case of non-stationary noise, it is set that μnz=μnz2. It is desirable to set μnz2 to be a relatively small value which is smaller than μnz1, for example, from about 0.7 to 0.8. In addition, it is desirable that μnz1 and μnz2 be adjusted to have values following changes in noise and not causing auditory discomfort in accordance with the characteristics of noise respectively presumed.

The a posteriori SNR computation section 29 computes an a posteriori SNR “γ(u,b)” of each band for each frame using the band power B(u,b) of an input signal and the noise band power estimation value D(u,b) based on the following formula (12). Note that this formula (12) is the same as the above-described formula (4). The a posteriori SNR computation section 29 constitutes an SNR computation section.

γ(u,b)=B(u,b)/D(u,b) (12)

The a priori SNR computation section 31 computes a priori SNR “ζ(u,b)” of each band for each frame based on the following formula (13). In this case, the a priori SNR computation section 31 uses a posteriori SNRs “γ(u−1,b), γ(u,b)” of the previous frame and the current frame, the noise suppression gain G′(u−1,b) of the previous frame, and a weighting coefficient α. Note that this formula (13) is the same as the above-described formula (5) except that the noise suppression gain G(u−1,b) is changed to the noise suppression gain G′(u−1,b) that has undergone modification using a limiting process.

ζ(u,b)=αG′²(u−1,b)y(u−1,b)+(1−α)P[γ(u,b)−1] (13)

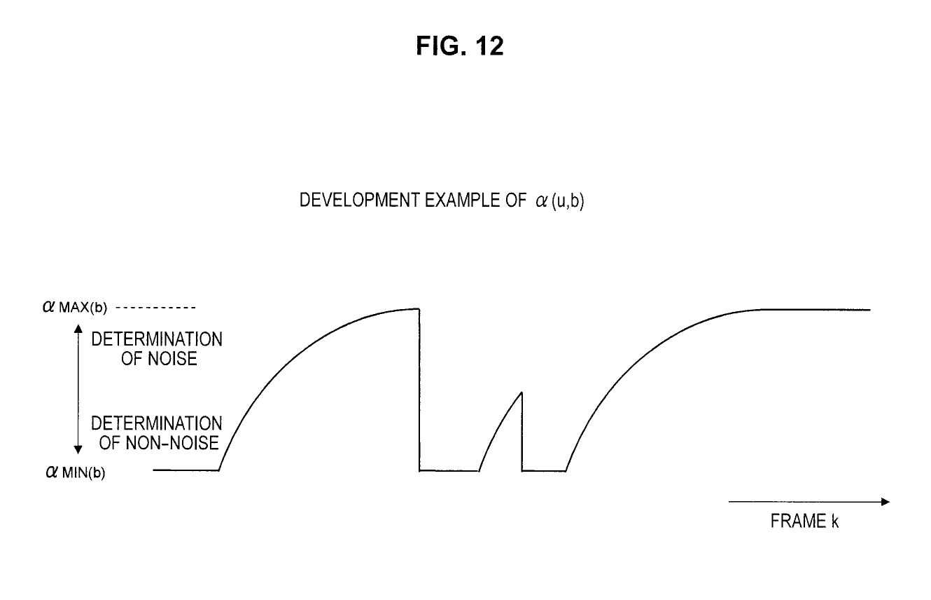

The α computation section 30 computes a weighting coefficient α in the above-described formula (13) as a weighting coefficient α(u,b) that is not a constant number and changes in a frame and a frequency band based on formula (14). αMAX(b) and an αMIN(b) are respectively maximum and minimum values of the weighting coefficient α(u,b) set for each band. When the weighting coefficient α(u,b) is computed based on formula (14), the weighting coefficient α(u,b) is approximated to the maximum value αMAX(b) in a band b determined to have noise and becomes the minimum value αMIN(b) in a band b determined to have non-noise. FIG. 12 shows a development example of the weighting coefficient α(u,b).

$$\begin{matrix}[ Math . 9 ] & \\ α ( u , b ) = \{ \begin{matrix}{μ}_{α} α ( u - 1 , b ) + ( 1 - {μ}_{α} ) {α}_{MAX} ( b ) & if {F}_{nz} ( u , b ) > 0 \\ {α}_{MIN} ( b ) & otherwise\end{matrix} & ( 14 )\end{matrix}$$

If α in the above-described formula (13) is rewritten in the form using α(u,b) described above, the following formula (15) is obtained.

ζ(u,b)=α(u−1,b)G′²(u−1,b)γ(u−1,b)+(1−α(u,b))P[γ(u,b)−1] (15)

The a priori SNR computation section 31 computes an a priori SNR “ζ(u,b)” based on the above-described formula (15). The a priori SNR “(u,b)” is computed using the mechanism of computation of the above-described weighting coefficient α(u,b) so that non-noise such as a voice generally having wild fluctuation is followed quickly while noise assumed to have stationarity is followed slowly. The a priori SNR computation section 31 constitutes an SNR smoothing section.

The noise suppression gain computation section 32 computes each noise suppression gain G(u,b) of each band for each frame from the a posteriori SNR “γ(u,b)” computed in the a posteriori SNR computation section 29 and the a priori SNR “ζ(u,b)” computed in the a priori SNR computation section 31 using the following formula (16). Note that this formula (16) is the same as the above-described formula (7).

$$\begin{matrix} [ Math . 10 ] & \\ G ( u , b ) = \frac{\sqrt{π}}{2} \frac{\sqrt{v ( u , b )}}{γ ( u , b )} exp ( - \frac{v ( u , b )}{2} ) [ ( 1 + v ( u , b ) ) {I}_{0} ( \frac{v ( u , b )}{2} ) + v ( u , b ) {I}_{1} ( \frac{v ( u , b )}{2} ) ] \\ [ where , v ( u , b ) = \frac{ξ ( u , b )}{1 + ξ ( u , b )} γ ( u , b ) ] & ( 16 )\end{matrix}$$

The noise suppression gain modification section 33 imposes a limit on the noise suppression g_{where,} [symbol] computed in the noise suppression gain computation section 32 based on the lower limit value GMIN(b) of the noise suppression gain set in advance for each band to compute a modified noise suppression gain G′(u,b). The following formula (17) expresses a limiting process executed in the noise suppression gain modification section 33.

$$\begin{matrix}[ Math . 11 ] & \\ {G}^{′} ( u , b ) = \{ \begin{matrix}{G}_{MIN} ( b ) & if G ( u , b ) < {G}_{MIN} ( b ) \\ G ( u , b ) & otherwise\end{matrix} & ( 17 )\end{matrix}$$

This noise suppression gain modification section 33 is provided in order to prevent a noise suppression gain from excessively decreasing, which is caused by excessive estimation of noise, while maximizing the amount of noise reduction for the auditory sense. Herein, the lower limit value GMIN(b) is set for each band based on the feature of a target sound source and auditory psychology. When a signal of non-noise is a voice, for example, the lower limit value of a noise suppression gain is set to be a higher value for a band having a high possibility of including a voice signal. When the noise suppression gain G(u,b) is lower than the lower limit value GMIN(b), the gain is replaced by the lower limit value GMIN(b). Accordingly, the quality of sound for the auditory sense deteriorates slightly even when there is error in the noise suppression gain G(u,b).

The filter constituting section 34 computes a noise suppression gain corresponding to each Fourier coefficient for each frame from the noise suppression gain G′(u,b) of each band of each frame modified in the noise suppression gain modification section 33 to constitute a filter on the frequency axis. The computation method may be a simple one using a gain obtained by performing inverse mapping for a gain obtained by performing band division for a Fourier coefficient in the band division section 21 without change, or may be one for further smoothing a gain on the frequency axis, which is obtained using the above method so as not to be discontinuous on the frequency axis.

An operation of the noise suppression gain generation unit 15 will be briefly described. Each frequency spectrum (each Fourier coefficient) obtained by performing a fast Fourier transform process for each frame in the fast Fourier transform unit 14 is supplied to the band division section 21 and the voiced band determination section 35. In the band division section 21, each frequency spectrum is divided into a predetermined number Nb, for example, 25 frequency bands for each frame (refer to Table 1).

The frequency spectrums of each band obtained from band division in the band division section 21 are supplied to the band power computation section 22 for each frame. In the band power computation section 22, band powers B(u,b) of each band are computed for each frame. For example, power spectrums corresponding to each frequency spectrum within a band b are respectively computed, and the maximum value or the average value is set as a band power B(u,b). This band power B(u,b) is supplied to the non-stationary noise determination section 36, the noise/non-noise determination section 27, the noise band power estimation section 28, and the a posteriori SNR computation section 29.

In addition, the framed signal yf(u,n) obtained in the framing unit 12 is supplied to the voiced sound detection section 23. In the voiced sound detection section 23, a voiced sound flag Fv(u) indicating whether a voiced sound is included is obtained for each frame based on the framed signal yf(u,n). In the voiced sound detection section 23, determination of noise or non-noise is made for the entire frame, and when determination of non-noise is made, it is set that Fv(u)=1, while when determination of noise is made, it is set that Fv(u)=0. Herein, the determination of noise or non-noise in the voiced sound detection section 23 is performed by detecting the zero-crossing width based on the framed signal yf(u,n) and calculating the histogram of the zero-crossing width.

In addition, the voiced sound flag Fv(u) obtained in the voiced sound detection section 23 is supplied to the voiced band determination section 35. In the voiced band determination section 35, the voiced sound flag Fv(u) and each frequency spectrum (each Fourier coefficient) obtained in the fast Fourier transform unit 14 are used, and a voiced band flag Pv(u,b) of each band is set for each frame. In this case, the voiced band flag Pv(u,b) is set in such a way that the amplitude of an input Fourier coefficient Y(u,k) of the u^{th} frame is examined, and whether the peak of a spectrum resulting from a voice is present in a band is checked for each band.

In addition, the voiced sound flag Fv(u) obtained in the voiced sound detection section 23 and the voiced band flag Pv(u,b) obtained in the voiced band determination section 35 are supplied to the non-stationary noise determination section 36. The non-stationary noise determination section 36 determines whether a signal of a band in which Pv(u,b)=0 is determined in the voiced band determination section 35 has the characteristics of non-stationary noise. In this case, first, a noise template BN(r,b) corresponding to target noise is searched for with respect to the band power B(u,b) of the current frame, and the closest noise template BN(rmin,b) is obtained.

After that, it is determined whether non-stationary noise is present in the corresponding frame. In this case, for the frames located ±S frames away from the current frame, a correlation l(u+s) of the template BN(rmin, b) obtained in the above description and the band power B(u+s,b) and a gain coefficient gN(u+s) are obtained. Then, the determination is made based on the conditions that the correlation l(u+s) not exceed lMAX and the variation of the gain coefficient gN(u+s) exceed the threshold value GNT, and a non-stationary noise flag Fnsn(u) is output.

In addition, the voiced sound flag Fv(u) of each frame obtained in the voiced sound detection section 23, the voiced band flag Pv(u,b) obtained in the voiced band determination section 35, and the non-stationary noise flag Fnsn(u) obtained in the non-stationary noise determination section 36 are supplied to the noise/non-noise determination section 27. The noise/non-noise determination section 27 sets a noise band flag Fnz(u,b) of each band for each frame using each of the flags and the band power B(u,b) of each band (refer to FIG. 11).

In this case, when determination of non-noise is made for all of the frames based on the fact that the non-stationary noise flag Fnsn(u) is 0 and the voiced sound flag Fv(u) is 1, it is determined that no bands are of noise and Fnz(u,b)=0 is satisfied in all bands.

In addition, when determination of noise is made for all of the frames based on the fact that the non-stationary noise flag Fnsn(u) is 0 but the voiced sound flag Fv(u) is 0, determination of noise or non-noise is made for each band by detecting stationarity of the band power. When the band power has stationarity and the band is determined to be a noise candidate, a noise candidate frame continuous counter Cn(b) of the band is counted up. Then, when the counted value exceeds the threshold value Tc, the band is determined to be of noise (have stationarity), and Fnz(u,b)=1 is satisfied.

On the other hand, when the band power does not have stationarity and the band is determined to be of non-noise, Fnz(u,b)=0 is satisfied. In addition, even when the band power has stationarity and the band is determined to be of a noise candidate, and when the counted value of the noise candidate frame continuous counter Cn(b) is equal to or lower than the threshold value Tc, the band is determined to be of non-noise and Fnz(u,b)=0 is satisfied.

In addition, when the non-stationary noise flag Fnsn(u) is 1 and the voiced band flag Pv(u,b) is 1, the band is determined not to be of noise, and Fnz(u,b)=0 is satisfied. In addition, when the non-stationary noise flag Fnsn(u) is 1 and the voiced band flag Pv(u,b) is 0, the band is determined to be of noise (non-stationary noise), and Fnz(u,b)=2 is satisfied.

The noise band flag Fnz(u,b) of each band set for each frame in the noise/non-noise determination section 27 is supplied to the noise band power estimation section 28. In addition, the band power B(u,b) of each band computed for each frame in the band power computation section 22 is supplied to the noise band power estimation section 28. The noise band power estimation section 28 estimates a noise band power estimation value D(u,b) of each band for each frame.

The noise band power estimation section 28 updates the noise band power estimation value D(u,b) only for a band in which Fnz(u,b)=1 and 2, in other words, a band of noise based on the noise band flag Fnz(u,b). For example, updating is performed using the band power B(u,b) and the index weight p.uz (refer to formula (11)). In this case, different values from the index weight μnz are used for stationary noise and non-stationary noise.

In other words, when Fnz(u,b)=1 in the case of stationary noise, μnz=μnz1 is satisfied. μnz1 is set a value, for example, from about 0.9 to 1.0 to the extent that the noise band power estimation value D(u,b) follows actual changes in noise and that auditory discomfort does not occur. In addition, when Fnz(u,b)=2 in the case of stationary noise, μnz=μnz2 is satisfied. μnz2 is set to a relatively small value which is smaller than μuz1, for example, from about 0.7 to 0.8. Accordingly, since the speed of following a change in non-stationary noise becomes higher than the speed of following a change in stationary noise, it is possible to avoid inconvenience that a reduction in noise is insufficiently attained or an adverse effect thereof arises in the voice.

The noise band power estimation value D(u,b) of each band estimated for each frame in the noise band power estimation section 28 is supplied to the a posteriori SNR computation section 29. In addition, the band power B(u,b) of each band computed for each frame in the band power computation section 22 is supplied to the a posteriori SNR computation section 29. The a posteriori SNR computation section 29 computes the a posteriori SNR “γ(u,b)” of each band using the band power B(u,b) and the noise band power estimation value D(u,b) for each frame (refer to formula (12)).

The noise band flag Fnz(u,b) of each band set for each frame in the noise/non-noise determination section 27 is supplied to the α computation section 30. The α computation section 30 computes the weighting coefficient α (u,b) for the computation of the a priori SNR “ζ(u,b)” (refer to formula (15)) of each band for each frame. The weighting coefficient α(u,b) is updated so as to be approximate to the maximum value αMAX(b) for the band b determined to be of noise and immediately set to the minimum value αMIN(b) for the band b determined to be of non-noise (refer to formula (14) and FIG. 12).

The a posteriori SNR “γ(u,b)” of each band computed for each frame in the a posteriori SNR computation section 29 is supplied to the a priori SNR computation section 31. In addition, the weighting coefficient α(u,b) of each band computed for each frame in the a computation section 30 is supplied to the a priori SNR computation section 31. Furthermore, the noise suppression gain G′(u,b) of each band of the previous frame that is modified in the noise suppression gain modification section 33 is supplied to the a priori SNR computation section 31. The a priori SNR computation section 31 computes an a priori SNR “4(u,b)” of each band for each frame (refer to formula (15)). In this case, a posteriori SNRs “γ(u−1,b) and γ(u,b)” of the previous frame and the current frame, the noise suppression gain G′(u−1,b) of the previous frame, and the weighting coefficient α(u,b) are used.

As described above, the weighting coefficient α(u,b) of each band computed in the α computation section 30 is updated so as to be approximate to the maximum value αMAX(b) in the band b determined to be of noise and immediately set to the minimum value αMIN(b) in the band b determined to be of non-noise. For this reason, the a priori SNR “ζ(u,b)” is calculated so that non-noise such as a voice generally having wild fluctuation is followed quickly while noise assumed to have stationarity is followed slowly.

The a posteriori SNR “γ(u,b)” of each band computed for each frame in the a posteriori SNR computation section 29 is supplied to the noise suppression gain computation section 32. In addition, the a priori SNR “ζ(u,b)” of each band computed for each frame in the a priori SNR computation section 31 is supplied to the noise suppression gain computation section 32. The noise suppression gain computation section 32 computes the noise suppression gain G(u,b) of each band for each frame from the a posteriori SNR “γ(u,b)” and the a priori SNR “ζ(u,b)” (refer to formula (16)).

The noise suppression gain G(u,b) of each band computed for each frame in the noise suppression gain computation section 32 is supplied to the noise suppression gain modification section 33. The noise suppression gain modification section 33 imposes a limit on the noise suppression gain G(u,b) of each band for each frame based on the lower limit value GMIN(b) of the noise suppression gain set in advance for each band to compute a modified noise suppression gain G′(u,b).

The noise suppression gain G′(u,b) of each band modified for each frame in the noise suppression gain modification section 33 is supplied to the filter constituting section 34. The filter constituting section 34 computes a noise suppression gain corresponding to each Fourier coefficient for each frame from the noise suppression gain G′(u,b) of each band. The noise suppression gain corresponding to each Fourier coefficient computed for each frame in the filter constituting section 34 as described above is supplied to the Fourier coefficient modification unit 16 as an output of the noise suppression gain generation unit 15.

As described above, in the noise suppressing device 10 shown in FIG. 4, the non-stationary noise determination section 36 of the noise suppression gain generation unit 15 determines whether noise is stationary noise or non-stationary noise in addition to determining whether a sound is noise or non-noise for each band so as to set a noise band flag Fnz(u,b). Then, the noise band power estimation section 28 estimates the noise band power estimation value D(u,b) of each band for each frame, and updates the noise band power estimation value D(u,b) only for a band of noise based on the noise band flag Fnz(u,b).

In this case, the index weight μnz2 of non-stationary noise is set to be smaller than the index weight μnz1 of stationary noise. For this reason, the speed of following changes in non-stationary noise is higher than the speed of following changes in stationary noise. Thus, when noise is non-stationary noise, it is possible to avoid inconvenience that a reduction in noise is insufficiently attained or an adverse effect thereof arises in the voice.

In addition, in the noise suppressing device 10 shown in FIG. 4, the noise suppression gain computation section 32 of the noise suppression gain generation unit 15 computes the noise suppression gain G(u,b) of each band from the a posteriori SNR “γ(u,b)” and the a priori SNR “ζ(u,b)”. In addition, the a priori SNR computation section 31 computes the a priori SNR “ζ(u,b)” of each band. In this case, a posteriori SNRs “γ(u−1,b) and γ(u,b)” of the previous frame and the current frame, the noise suppression gain G′(u−1,b) of the previous frame, and the weighting coefficient α(u,b) are used.

The weighting coefficient α(u,b) of each band computed in the α computation section 30 is adaptively changed in accordance with the state of a signal. In other words, the weighting coefficient α(u,b) is updated so as to be approximate to the maximum value αMAX(b) in the band b (Fnz(u,b)=1) determined to be of noise and immediately set to the minimum value αMIN(b) for the band b (Fnz(u,b)=0) determined to be of non-noise. For this reason, the a priori SNR “ζ(u,b)” is computed so that non-noise such as a voice generally having wild fluctuation is followed quickly while noise assumed to have stationarity is followed slowly.

For this reason, the accuracy (following property) of the noise suppression gain G(u,b) of each band computed in the noise suppression gain generation unit 15 can improve. Thus, deterioration of sound quality occurring at a location such as the beginning part of a voice signal at which the signal greatly changes can be suppressed, and musical noise at a location such as a section of stationary noise at which the signal slowly changes can be suppressed, whereby the improvement of sound quality can be attained.

In addition, as described above, in the noise suppressing device 10 shown in FIG. 4, the noise/non-noise determination section 27 of the noise suppression gain generation unit 15 sets the noise band flag Fnz(u,b) of each band using the voiced sound flag Fv(u) and the band power B(u,b) of each band. In other words, noise in a band not overlapping with non-noise can also be detected in a signal in which noise and non-noise are mixed. In addition, the noise band power estimation section 28 updates the noise band power estimation value D(u,b) only for a band with Fnz(u,b)=1, 2, in other words, a band of noise based on the noise band power Fnz(u,b). For this reason, the time following property in estimating the noise band power estimation value D(u,b) can improve and the estimation accuracy can be enhanced. As a result, the accuracy of the noise suppression gain can be enhanced, whereby the improvement of sound quality can be attained.

In addition, as described above, in the noise suppressing device 10 of FIG. 4, the noise/non-noise determination section 27 of the noise suppression gain generation unit 15 sets the noise band flag Fnz(u,b) of each band using the voiced sound flag Fv(u) and the band power B(u,b) of each band. In other words, the noise/non-noise determination section 27 performs noise/non-noise determination on all of the frames using the voiced sound flag Fv(u), and by combining the determination and determination for each band based on detection of stationarity of the band power, the final determination result is obtained. Accordingly, the accuracy of determining noise or non-noise for each band can improve.

In addition, as described above, in the noise suppressing device 10 of FIG. 4, the noise suppression gain modification section 33 of the noise suppression gain generation unit 15 computes a modified noise suppression gain G′(u,b). In this case, a limit is imposed on the noise suppression gain G(u,b) of each band based on the lower limit value GMIN(b) of the noise suppression gain set in advance for each band, and modification thereof is performed. Thus, deterioration in sound quality caused by estimation error or the like can be suppressed to the minimum while the amount of reduction in auditory noise is maximized.

Note that, in the noise suppressing device 10 of FIG. 4, the noise/non-noise determination section 27 of the noise suppression gain generation unit 15 sets the noise band flag Fnz(u,b) of each band using the voiced sound flag Fv(u) and the band power B(u,b) of each band. However, it may also be considered that the noise/non-noise determination section 27 sets the noise band flag Fnz(u,b) of each band for each frame using only one of the voiced sound flag Fv(u) and the band power B(u,b).

When the noise band flag Fnz(u,b) of each band is set only using the voiced sound flag Fv(u), the noise/non-noise determination section 27 performs the determination process, for example, except for the process of Step ST7 in the flowchart of FIG. 11. On the other hand, when the noise band flag Fnz(u,b) of each band is set only using the band power B(u,b), the noise/non-noise determination section 27 performs the determination process, for example, except for the process of Step ST3 in the flowchart of FIG. 11.

### 2. Second Embodiment

### Noise Suppressing Device

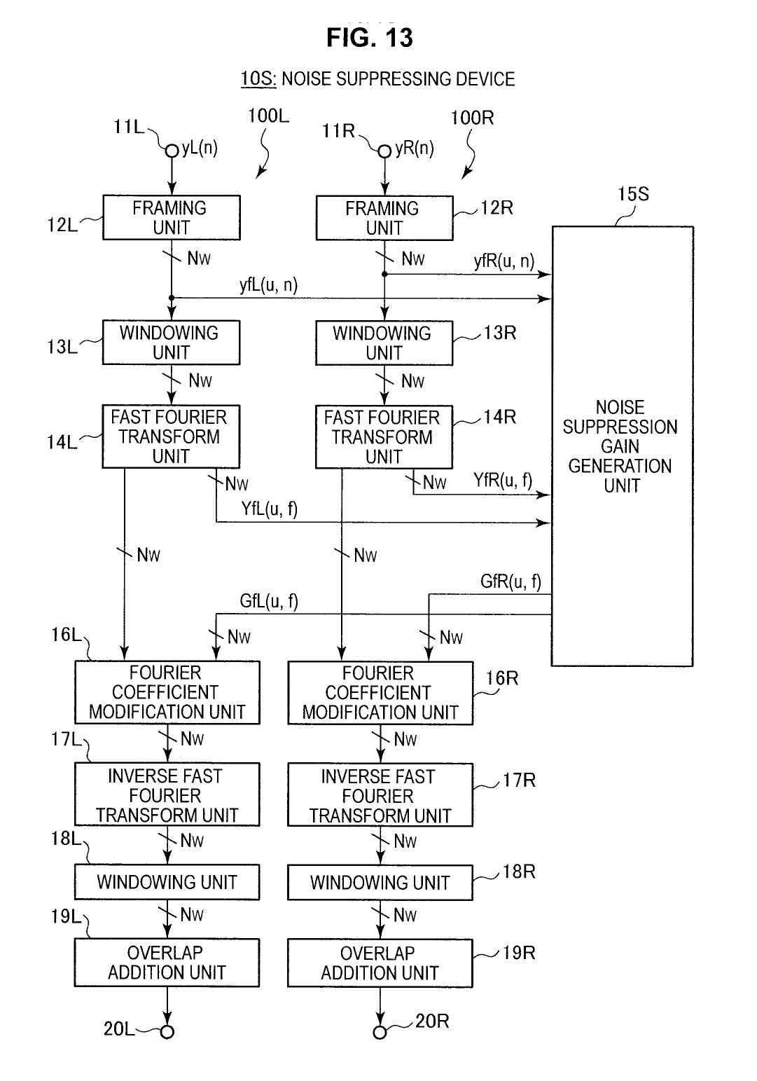

FIG. 13 shows a configuration example of a noise suppressing device 10S as a second embodiment. While the noise suppressing device 10 shown in FIG. 4 is of a configuration example of a case in which the device is applied to noise suppression of a monaural signal, this noise suppressing device 10S is of a configuration example of a case in which the device is applied to noise suppression of a stereo signal. In FIG. 13, portions corresponding to those of FIG. 4 are indicated by the same reference numerals, or with a letter “L” or “R” affixed thereto, and detailed description thereof will be appropriately omitted. When the device is applied to a stereo signal, basically, the process for a monaural signal may be performed for each channel. However, in the case of a stereo signal, a negative effect arises in which the orientation of a processing result collapses due to estimation error, or the like. For this reason, a different method is used for such a stereo signal.

The noise suppressing device 10S includes a left channel (Lch) processing system 100L, a right channel (Rch) processing system 100R, and a noise suppression gain generation unit 15S. The left channel processing system 100L and the right channel processing system 100R include the same processing system from the signal input terminal 11 to the signal output terminal 20 of the noise suppressing device 10 shown in FIG. 4.

In other words, the left channel processing system 100L has a signal input terminal 11L, a framing unit 12L, a windowing unit 13L, and a fast Fourier transform unit 14L. In addition, the left channel processing system 100L has a Fourier coefficient modification unit 16L, an inverse fast Fourier transform unit 17L, a windowing unit 18L, an overlap addition unit 19L, and a signal output terminal 20L.

In addition, the right channel processing system 100R has a signal input terminal 11R, a framing unit 12R, a windowing unit 13R, and a fast Fourier transform unit 14R. In addition, the right channel processing system 100R has a Fourier coefficient modification unit 16R, an inverse fast Fourier transform unit 17R, a windowing unit 18R, an overlap addition unit 19R, and a signal output terminal 20R.

The noise suppression gain generation unit 15S generates a noise suppression gain corresponding to each Fourier coefficient of the left channel processing system 100L and a noise suppression gain corresponding to each Fourier coefficient of the right channel processing system 100R for each frame. This noise suppression gain generation unit 15S generates noise suppression gain GfL(u,f) and GfR(u,f) corresponding to each Fourier coefficient of the left channel processing system 100L and the right channel processing system 100R. In this case, the noise suppression gain generation unit 15S generates the noise suppression gains GfL(u,f) and GfR(u,f) of each channel based on a framed signal and each Fourier coefficient (each frequency spectrum). Details of the noise suppression gain generation unit 15S will be described later.

An operation of the noise suppressing device 10S will be briefly described. In the left channel processing system 100L, an input signal yL(n) of the left channel is supplied to the signal input terminal 11L, and this input signal yL(n) is supplied to the framing unit 12L. In this framing unit 12L, the input signal yL(n) is framed in order to perform a process for each frame. In other words, in this framing unit 12L, the input signal yL(n) is divided into frames having a predetermined frame length, for example, the frame length of Nf samples. Framed signals yfL(u,n) of each frame are sequentially supplied to the windowing unit 13L.

In the windowing unit 13L, windowing is performed on the framed signals yfL(u,n) using an analysis window wana(n) in order to obtain a Fourier coefficient that is stable in the fast Fourier transform unit 14L to be described later. The framed signals yfL(u,n) that have undergone windowing are supplied to the fast Fourier transform unit 14L. In the fast Fourier transform unit 14L, a fast Fourier transform process is performed on the windowed framed signals yfL(u,n) so as to convert time domain signals to frequency domain signals. Each Fourier coefficient YfL(u,f) (each frequency spectrum) obtained in the fast Fourier transform process is supplied to the Fourier coefficient modification unit 16L. Note that (u,f) indicates the f^{th} frequency of the u^{th} frame.

In addition, in the right channel processing system 100R, an input signal yR(n) of the right channel is supplied to the signal input terminal 11R, and this input signal yR(n) is supplied to the framing unit 12R. In this framing unit 12R, the input signal yR(n) is framed in order to perform a process for each frame. In other words, in this framing unit 12R, the input signal yR(n) is divided into frames having a predetermined frame length, for example, the frame length of Nf samples. Framed signals yfR(u,n) of each frame are sequentially supplied to the windowing unit 13R.

In the windowing unit 13R, windowing is performed on the framed signals yfR(u,n) using the analysis window wana(n) in order to obtain a Fourier coefficient that is stable in the fast Fourier transform unit 14R to be described later. The framed signals yfR(u,n) that have undergone windowing are supplied to the fast Fourier transform unit 14R. In the fast Fourier transform unit 14R, a fast Fourier transform process is performed on the windowed framed signals yfR(u,n), so as to convert time domain signals into frequency domain signals. Each Fourier coefficient YfR(u,f) (each frequency spectrum) obtained in the fast Fourier transform process is supplied to the Fourier coefficient modification unit 16R. Note that (u,f) indicates the f^{th} frequency of the u^{th} frame.

Framed signals yfL(u,n) and yfR(u,n) of each frame obtained in the framing units 12L and 12R are supplied to the noise suppression gain generation unit 15S. In addition, Fourier coefficients YfL(u,n) and YfR(u,n) of each frame obtained in the fast Fourier transform units 14L and 14R are supplied to the noise suppression gain generation unit 15S. In the noise suppression gain generation unit 15S, a noise suppression gain corresponding to each Fourier coefficient common in the left and right channels is generated for each frame based on the framed signals yfL(u,n) and yfR(u,n) and the Fourier coefficients YfL(u,n) and YfR(u,n).

In addition, in the Fourier coefficient modification unit 16L of the left channel processing system 100L, each Fourier coefficient YfL(u,n) obtained from the fast Fourier transform process in the fast Fourier transform unit 14L is modified for each frame. In this case, the product of each Fourier coefficient YfL(u,n) and a noise suppression gain GfL(u,f) corresponding to each Fourier coefficient generated in the noise suppression gain generation unit 15S is taken to modify the coefficient. In other words, in the Fourier coefficient modification unit 16L, filter calculation for suppressing noise is performed on the frequency axis. Each modified Fourier coefficient is supplied to the inverse fast Fourier transform unit 17L.

In the inverse fast Fourier transform unit 17L, an inverse fast Fourier transform process is performed on each Fourier coefficient that has been modified for each frame so as to convert frequency domain signals to time domain signals. The framed signals obtained in the inverse fast Fourier transform unit 17L are supplied to the windowing unit 18L. In this windowing unit 18L, windowing is performed on the framed signals obtained in the inverse fast Fourier transform unit 17L using the synthesis window wsyn(n).

The framed signals of each frame that have been windowed in the windowing unit 18L are supplied to the overlap addition unit 19L. In this overlap addition unit 19L, overlapping of the framed signals of each frame is performed on the frame boundary portions and output signals whose noise is suppressed are obtained. Then, the output signals are output to the signal output terminal 20L of the left channel processing system 100L.

In addition, in the Fourier coefficient modification unit 16R of the right channel processing system 100R, each Fourier coefficient YfR(u,n) obtained from the fast Fourier transform process in the fast Fourier transform unit 14R is modified for each frame. In this case, the product of each Fourier coefficient YfR(u,n) and a noise suppression gain GfR(u,f) corresponding to each Fourier coefficient generated in the noise suppression gain generation unit 15S is taken to modify the coefficient. In other words, in the Fourier coefficient modification unit 16R, filter calculation for suppressing noise is performed on the frequency axis. Each modified Fourier coefficient is supplied to the inverse fast Fourier transform unit 17R.

In the inverse fast Fourier transform unit 17R, an inverse fast Fourier transform process is performed on each Fourier coefficient that has been modified for each frame so as to convert frequency domain signals to time domain signals. The framed signals obtained in the inverse fast Fourier transform unit 17R are supplied to the windowing unit 18R. In this windowing unit 18R, windowing is performed on the framed signals obtained in the inverse fast Fourier transform unit 17R using the synthesis window wsyn(n).

The framed signals of each frame that have been windowed in the windowing unit 18R are supplied to the overlap addition unit 19R. In this overlap addition unit 19R, overlapping of the framed signals of each frame is performed on the frame boundary portions and output signals whose noise is suppressed are obtained. Then, the output signals are output to the signal output terminal 20R of the right channel processing system 100R.

[Noise Suppression Gain Generation Unit]

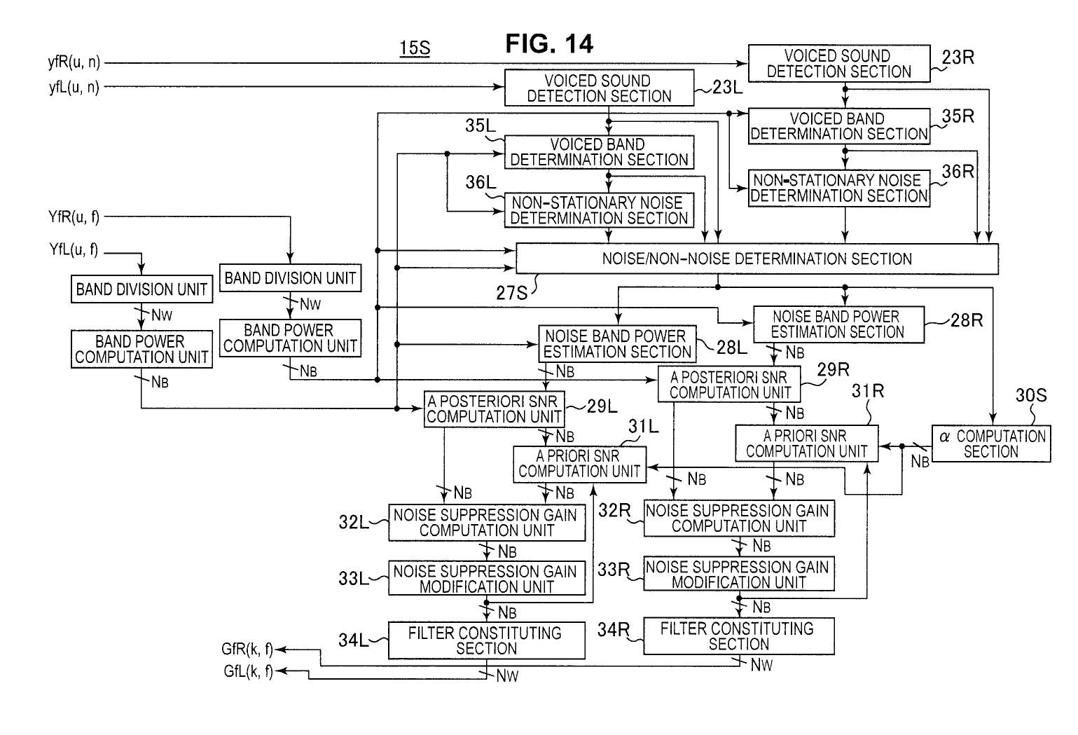

Details of the noise suppression gain generation unit 15S will be described. FIG. 14 shows a configuration example of the noise suppression gain generation unit 15S. In FIG. 14, portions corresponding to those of FIG. 4 are indicated by the same reference numerals, or the letters “L”, “R”, and “S” may be affixed thereto, and detailed description thereof will be appropriately omitted. Herein, “L” indicates a processing part on the left channel side, “R” indicates a processing part on the right channel side, and “S” indicates a processing part common in the left and right channels.

The noise suppression gain generation unit 15S has band division sections 21L and 21R, band power computation sections 22L and 22R, voiced sound detection sections 23L and 23R, voiced band determination sections 35L and 35R, and non-stationary noise determination sections 36L and 36R. In addition, the noise suppression gain generation unit 15S has a noise/non-noise determination section 27S and noise band power estimation sections 28L and 28R. Moreover, the noise suppression gain generation unit 15S has a posteriori SNR computation sections 29L and 29R, an a computation section 30S, a priori SNR computation sections 31L and 31R, noise suppression gain computation sections 32L and 32R, noise suppression gain modification sections 33L and 33R, and filter constituting sections 34L and 34R.

The band division sections 21L and 21R have the same configuration as the band division section 21 of the noise suppression gain generation unit 15 of the noise suppressing device 10 shown in FIG. 4. The band division sections 21L and 21R divide each of the frequency spectrums (each of the Fourier coefficients) YfL(u,f) and YfR(u,f) obtained in the fast Fourier transform units 14L and 14R into, for example, 25 frequency bands (refer to Table 1). The band power computation sections 22L and 22R have the same configuration as the band power computation section 22 of the noise suppression gain generation unit 15 of the noise suppressing device 10 shown in FIG. 4. The band power computation sections 22L and 22R compute band powers BL(u,b) and BR(u,b) from the frequency spectrums for each band divided in the band division sections 21L and 21R.

The voiced sound detection sections 23L and 23R have the same configuration as the voiced sound detection section 23 of the noise suppression gain generation unit 15 of the noise suppressing device 10 shown in FIG. 4. The voiced sound detection sections 23L and 23R output voiced sound flags FvL(u) and FvR(u) indicating whether a voiced sound is included for each frame based on the framed signals yfL(u,n) and yfR(u,n) obtained in the framing units 12L and 12R.

The voiced band determination sections 35L and 35R have the same configuration as the voiced band determination section 35 of the noise suppression gain generation unit 15 of the noise suppressing device 10 shown in FIG. 4. The voiced band determination sections 35L and 35R output voiced band flags PvL(u,b) and PvR(u,b) indicating whether a band is a voiced band for each frame and each band based on the voiced sound flags FvL(u) and FvR(u) obtained in the voiced sound detection sections 23L and 23R and the band powers BL(u,b) and BR(u,b) of each band computed in the band power computation sections 22L and 22R.

The non-stationary noise determination sections 36L and 36R have the same configuration as the non-stationary noise determination section 36 of the noise suppression gain generation unit 15 of the noise suppressing device 10 shown in FIG. 4. The non-stationary noise determination sections 36L and 36R output non-stationary noise flags FnsnL(u) and FnsnR(u) indicating whether a frame is one including non-stationary noise for each frame based on the voiced band flags PvL(u,b) and PvR(u,b) obtained in the voiced band determination sections 35L and 35R, and the band powers BL(u,b) and BR(u,b) each band computed in the band power computation sections 22L and 22R.

The noise/non-noise determination section 27S has substantially the same configuration as the noise/non-noise determination section 27 of the noise suppression gain generation unit 15 of the noise suppressing device 10 shown in FIG. 4. This noise/non-noise determination section 27S is designed to respond to stereo, and sets a noise band flag Fnz(u,b) of each band common in the left and right channels for each frame.

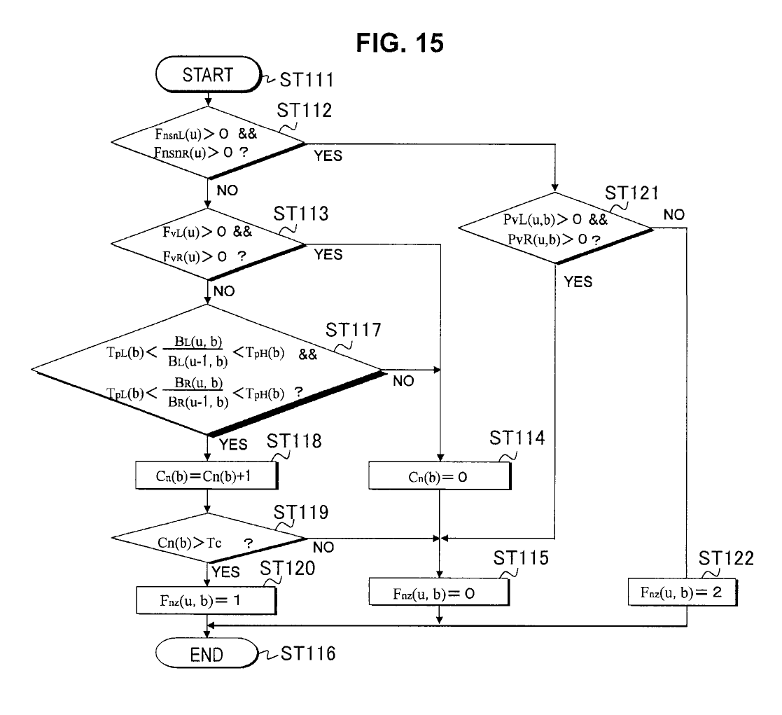

The noise/non-noise determination section 27S sets the noise band flag Fnz(u,b) of each band. In this case, the noise/non-noise determination section 27S uses the voiced sound flags FvL(u) and FvR(u) obtained in the voiced sound detection sections 23L and 23R and the band powers BL(u,b) and BR(u,b) of each band computed in the band power computation sections 22L and 22R. Furthermore, the noise/non-noise determination section 27S uses the voiced band flags PvL(u,b) and PvR(u,b) obtained in the voiced band determination sections 35L and 35R and the non-stationary noise flags FnsnL(u) and FnsnR(u) obtained in the non-stationary noise determination sections 36L and 36R. The noise/non-noise determination section 27S executes the determination process described in the flowchart of FIG. 15 in each band for each frame.

The noise/non-noise determination section 27S starts the determination process in Step ST111 to initialize the system. In this initialization, the noise/non-noise determination section 27S initializes a noise candidate frame continuous counter Cn(b) so as to satisfy Cn(b)=0.

Next, the noise/non-noise determination section 27S moves to the process of Step ST112. In this Step ST112, the noise/non-noise determination section 27S determines whether the non-stationary noise flags FnsnL(u) and FnsnR(u) are greater than 0, in other words, whether FnsnL(u) and FnsnR(u) are 1. When FnsnL(u)=1 and FnsnR(u)=1 are not satisfied, in other words, when at least one of the left or right channels of a current frame u does not include non-stationary noise, the noise/non-noise determination section 27S moves to the process of Step ST113.

In Step ST113, the noise/non-noise determination section 27S determines whether the voiced sound flags FvL(n) and FvR(n) are greater than 0, in other words, whether FvL(n) and FvR(n) are 1. When FvL(n)=1 and FvR(n)=1 are satisfied, in other words, when the current frame u includes a voiced sound commonly in the left and right channels, the noise/non-noise determination section 27S clears the noise candidate frame continuous counter Cn(b) so as to satisfy Cn(b)=0 in Step ST114. Then, the noise/non-noise determination section 27S determines that a current band h is not of noise, sets the noise band flag Fnz(u,b) as Fnz(u,b)=0 in Step ST115, and then finishes the determination process in Step ST116.

When FvL(n)=1 and FvR(n)=1 are not satisfied in Step ST113, in other words, when at least one of the left or right channels of the current frame u is not of a voiced sound, the noise/non-noise determination section 27S moves to the process of Step ST117. In Step ST117, the noise/non-noise determination section 27S obtains the power ratio of the band power BL(u,b) of the current frame u on the left channel side to a band power BL(u−1,b) of the previous frame u−1. In addition, in Step ST117, the noise/non-noise determination section 27S obtains the power ratio of the band power BR(u,b) of the current frame u on the right channel side to a band power BR(u−1,b) of the previous frame u−1.

Then, the noise/non-noise determination section 27S determines whether both power ratios of the right and left channels fall within the range between the threshold value TpL(b) on the low level side and the threshold value TpH(b) on the high level side in Step ST117. In other words, it is determined whether TpL(b)<BL(u,b)/BL(u−1,b)<TpH(b) and TpL(b)<BR(u,b)/BR(u−1,b)<TpH(b) are satisfied.

When both power ratios of the right and left channels fall within the range between the threshold values, the noise/non-noise determination section 27S sets a current band b as a candidate of noise, and when both power ratios of the right and left channels do not fall within the range between the threshold values, the noise/non-noise determination section 27S determines that the current band b is not of noise. This determination is based on the assumption that the power of a noise signal is constant, and in contrast, that a signal of which the power greatly changes is not of noise.

When both power ratios of the right and left channels do not fall within the range between the threshold values, the noise/non-noise determination section 27S clears the noise candidate frame continuous counter Cn(b) so as to set Cn(b)=0 in Step ST114. Then, the noise/non-noise determination section 27S determines that the current band b is not of noise, sets Fnz(k,b)=0 in Step ST115, and then finishes the determination process in Step ST116.

On the other hand, when both power ratios of the right and left channels fall within the range between the threshold values, in other words, when the current band b is a candidate of noise, the noise/non-noise determination section 27S moves to the process of Step ST118. In Step ST118, the noise/non-noise determination section 27S counts up the noise candidate frame continuous counter Cn(b) by one.

Then, the noise/non-noise determination section 27S determines whether the noise candidate frame continuous counter Cn(b) exceeds a threshold value Tc in Step ST119. When Cn(b)>Tc is not satisfied, the noise/non-noise determination section 27S determines that the current band b is not of noise, sets Fnz(u,b)=0 in Step ST115, and then finishes the determination process in Step ST116.

On the other hand, when Cn(b)>Tc is satisfied, the noise/non-noise determination section 27S moves to the process of Step ST120. In Step ST120, the noise/non-noise determination section 27S determines that the current band b is of noise, sets the noise band flag Fnz(u,b) to satisfy Fnz(u,b)=1, and then finishes the determination process in Step ST116.

In addition, when FnsnL(u)=1 and FnsnR(u)=1 are satisfied in Step ST112, in other words, when both right and left channels of the current frame u include non-stationary noise, the noise/non-noise determination section 27S moves to the process of Step ST121. In Step ST121, the noise/non-noise determination section 27S determines whether the voiced band flags PvL(u,b) and PvR(u,b) are greater than 0, in other words, whether the voiced band flags PvL(u,b) and PvR(u,b) are 1.

When PvL(u,b)=1 and PvR(u,b)=1 are satisfied, in other words, when both right and left channels are of voiced bands, the noise/non-noise determination section 27S sets the noise band flag Fnz(u,b) to satisfy Fnz(u,b)=0 in Step ST115, and then finishes the determination process in Step ST116. On the other hand, when any one of PvL(u,b) and PvR(u,b) is 0, the noise/non-noise determination section 27S determines that the current band b is of noise (non-stationary noise), sets the noise band flag Fnz(u,b) to satisfy Fnz(u,b)=2 in Step ST122, and then finishes the determination process in Step ST116.

Returning to FIG. 14, the noise band power estimation sections 28L and 28R have the same configuration as the noise band power estimation section 28 of the noise suppression gain generation unit 15 of the noise suppressing device 10 shown in FIG. 4. The noise band power estimation sections 28L and 28R estimate noise band power estimation values DL(u,b) and DR(u,b) of each band for each frame. The noise band power estimation sections 28L and 28R update the noise band power estimation values DL(u,b) and DR(u,b) only for a band in which Fnz(u,b)=1 is satisfied, in other words, a band of noise (refer to formula (11)). In this case, the noise band power estimation sections 28L and 28R perform a process based on the noise band flag Fnz(u,b) common in the right and left channels set in the noise/non-noise determination section 27S.

The a posteriori SNR computation sections 29L and 29R have the same configuration as the a posteriori SNR computation section 29 of the noise suppression gain generation unit 15 of the noise suppressing device 10 shown in FIG. 4. The a posteriori SNR computation sections 29L and 29R compute a posteriori SNRs “γL(u,b) and γR(u,b)” of each band for each frame (refer to formula (12)). In this case, the a posteriori SNR computation sections 29L and 29R use the band powers BL(u,b) and BR(u,b) and the noise band power estimation values DL(u,b) and DR(u,b) of an input signal.

The a priori SNR computation sections 31L and 31R have the same configuration as the a priori SNR computation section 31 of the noise suppression gain generation unit 15 of the noise suppressing device 10 shown in FIG. 4. The a priori SNR computation sections 31L and 31R compute a priori SNRs “ζL(u,b) and ζR(u,b)” of each band for each frame (refer to formula (15)).

Herein, the a priori SNR computation section 31L computes the a priori SNR “ζL(u,b)” of each band. In this case, the a priori SNR computation section 31L uses a posteriori SNRs “γL(u−1,b) and γL(u,b)” of the previous frame and the current frame, the noise suppression gain G′L(u−1,b) of the previous frame, and a weighting coefficient α(u,b) common in the right and left channels. In addition, the a priori SNR computation section 31R computes the a priori SNR “ζR(u,b)” of each band. In this case, the a priori SNR computation section 31R uses a posteriori SNRs “yR(u−1,b) and γR(u,b)” of the previous frame and the current frame, the noise suppression gain G′R(u−1,b) of the previous frame, and the weighting coefficient α(u,b) common in the right and left channels.

The α computation section 30S has the same configuration as the α computation section 30 of the noise suppressing device 10 shown in FIG. 4, and computes a weighting coefficient α(u,b) common in the right and left channels used in the a priori SNR computation sections 31L and 31R. The α computation section 30S computes the coefficient as a weighting coefficient α(u,b) that is not a constant number and changes in frames and bands (refer to formula (14)). This weighting coefficient α(u,b) becomes approximate to the maximum value αMAX(b) in a band b determined to include noise (Fnz(u,b)=1, 2) and becomes the minimum value αMIN(b) in a band b determined to include non-noise (Fnz(u,b)=0).

The noise suppression gain computation sections 32L and 32R have the same configuration as the noise suppression gain computation section 32 of the noise suppression gain generation unit 15 of the noise suppressing device 10 shown in FIG. 4. The noise suppression gain computation sections 32L and 32R compute noise suppression gains GL(u,b) and GR(u,b) of each band for each frame (refer to formula (16)). In this case, the noise suppression gain computation sections 32L and 32R compute the noise suppression gains GL(u,b) and GR(u,b) of each band from the a posteriori SNRs “γL(u,b) and γR(u,b)” and the a priori SNRs “ζL(u,b) and ζR(u,b)”.

The noise suppression gain modification sections 33L and 33R have the same configuration as the noise suppression gain modification section 33 of the noise suppression gain generation unit 15 of the noise suppressing device 10 shown in FIG. 4. The noise suppression gain modification sections 33L and 33R modify the noise suppression gains GL(u,b) and GR(u,b) computed in the noise suppression gain computation sections 32L and 32R for each frame. In other words, the noise suppression gain modification sections 33L and 33R compute modified noise suppression gains G′L(u,b) and G′R(u,b) (refer to formula (17)). In this case, the noise suppression gain modification sections 33L and 33R impose a limit on the noise suppression gains GL(u,b) and GR(u,b) based on the lower limit value GMIN(b) of the noise suppression gain that is set in advance for each band.

The filter constituting sections 34L and 34R have the same configuration as the filter constituting section 34 of the noise suppression gain generation unit 15 of the noise suppressing device 10 shown in FIG. 4. The filter constituting sections 34L and 34R compute noise suppression gains GfL(u,f) and GfR(u,f) corresponding to each Fourier coefficient for each frame based on the noise suppression gains G′L(u,b) and G′R(u,b) modified in the noise suppression gain modification sections 33L and 33R. In this case, the filter constituting sections 34L and 34R constitute a filter on the frequency axis.

An operation of the noise suppression gain generation unit 15S will be briefly described. Each of frequency spectrums (each of Fourier coefficients) YfL(u,f) and YfR(u,f) obtained from a fast Fourier transform process for each frame in the fast Fourier transform units 14L and 14R is supplied to the band division sections 21L and 21R. In the band division sections 21L and 21R, each of the frequency spectrums YfL(u,f) and YfR(u,f) is divided into a predetermined number Nb, for example, 25 frequency bands for each frame (refer to Table 1).

The frequency spectrums of each band obtained by dividing bands thereof in the band division sections 21L and 21R are supplied to the band power computation sections 22L and 22R for each frame. In the band power computation sections 22L and 22R, the band powers BL(u,b) and BR(u,b) of each band are computed for each frame. For example, power spectrums corresponding to each of the frequency spectrums within the band b are respectively computed, and the maximum value or the average value thereof is set as the band powers BL(u,b) and BR(u,b).

In addition, the framed signals yfL(u,n) and yfR(u,n) obtained in the framing units 12L and 12R are supplied to the voiced sound detection sections 23L and 23R. In the voiced sound detection sections 23L and 23R, based on the framed signals yfL(u,n) and yfR(u,n), voiced sound flags FvL(u) and FvR(u) indicating whether a frame includes a voiced sound are obtained for each frame. In the voiced sound detection sections 23L and 23R, determination of noise or non-noise is made for all of the frames, and when determination of non-noise is made, FvL(u) and FvR(u) are equal to 1, while when determination of noise is made, FvL(u) and FvR(u) are equal to 0. Herein, the determination of noise or non-noise in the voiced sound detection sections 23L and 23R is made by detecting the zero-crossing width based on the framed signals yfL(u,n) and yfR(u,n) and calculating the histogram of the zero-crossing width.

In addition, the voiced sound flags FvL(u) and FvR(u) obtained in the voiced sound detection sections 23L and 23R are supplied to the voiced band determination sections 35L and 35R. In the voiced band determination sections 35L and 35R, the voiced sound flags FvL(u) and FvR(u) and each of the frequency spectrums (each of the Fourier coefficients) obtained in the fast Fourier transform units 14L and 14R are used for each frame, and the voiced band flags PvL(u,b) and PvR(u,b) of each band are set. In this case, the amplitudes of input Fourier coefficients YfL(u,k) and YfR(u,k) of the u^{th} frame are examined, and whether the peak of each spectrum resulting from a voice is present in a band is checked for each band to set the voiced band flags PvL(u,b) and PvR(u,b).

In addition, the voiced band flags PvL(u,b) and PvR(u,b) obtained in the voiced band determination sections 35L and 35R are supplied to the non-stationary noise determination sections 36L and 36R. In the non-stationary noise determination sections 36L and 36R, each of the frequency spectrums (each of the Fourier coefficients) obtained in the fast Fourier transform units 14L and 14R is used to set the non-stationary noise flags FnsnL(u) and FnsnR(u) for each frame.

In this case, it is determined whether a signal of a band that PvL(u,b) and PvR(u,b)=0 are set in the voiced band determination sections 35L and 35R has the characteristics of non-stationary noise. In this case, first, a noise template BN(r,b) corresponding to target noise is searched for with respect to the band powers BL(u,b) and BR(u,b) of the current frame to obtain the closest noise templates BNL(rmin, b) and BNR(rmin,b).

After that, it is determined whether the corresponding frame has non-stationary noise. In this case, for the frames located ±S frames away from the current frame, a correlation l(u+s) of the templates BNL(rmin, b) and BNR(rmin,b) obtained in the above description and the band power B(u+s,b) and a gain coefficient gN(u+s) are obtained. Then, the determination is made based on the conditions that the correlation 1(u+s) does not exceed lMAX, and the variation of the gain coefficient gN(u+s) exceeds the threshold value GNT, and non-stationary noise flags FnsnL(u) and FnsnR(u) are obtained.

The voiced sound flags FvL(u) and FvR(u) of each frame obtained in the voiced sound detection sections 23L and 23R are supplied to the noise/non-noise determination section 27S. In addition, the voiced sound flags FvL(u) and FvR(u) of each frame obtained in the voiced sound detection sections 23L and 23R are supplied to the noise/non-noise determination section 27S. In addition, the voiced band flags PvL(u,b) and PvR(u,b) obtained in the voiced band determination sections 35L and 35R are supplied to the noise/non-noise determination section 27S. Furthermore, the band powers BL(u,b) and BR(u,b) of each band of each frame computed in the band power computation sections 22L and 22R are supplied to the noise/non-noise determination section 27S. In the noise/non-noise determination section 27S, the noise band flag Fnz(u,b) of each band common in the right and left channels is set for each frame using the band powers BL(u,b) and BR(u,b) of the each band and each of the flags (refer to FIG. 15).

In this case, when FvL(u) and FvR(u)=1 are satisfied and both right and left channels are determined to be of non-noise for the entire frame, all of bands are determined not to be of noise, and Fnz(u,b)=0 is satisfied in all of the bands.

In addition, when FvL(u)=1 and FvR(u)=1 are not satisfied and both right and left channels are not determined to be of non-noise for the entire frame, the determination of noise or non-noise is made by detecting the stationarity of a band power for each band. When a band power has stationarity in both right and left channels and the band is determined to be of a noise candidate, the noise candidate frame continuous counter Cn(b) of the band is counted up. Then, when the counted value exceeds the threshold value Tc, the band is determined to be of noise, and Fnz(u,b)=1 is set.

On the other hand, when the band power does not have stationarity in both or any one of the right and left channels and the band is determined to be of non-noise, Fnz(u,b)=0 is set. In addition, even when the band power has stationarity in both of the right and left channels and the band is determined to be of a noise candidate, and when the counted value of the noise candidate frame continuous counter Cn(b) is lower than or equal to the threshold value Tc, the band is determined to be of non-noise and Fnz(u,b)=0 is set.

In addition, when FnsnL(u)=1 and FnsnR(u)=1 are not satisfied, and PvL(u,b)=1 and PvR(u,b)=1 are satisfied, the band is determined not to be of noise,

and Fnz(u,b)=0 is set. In addition, when FnsnL(u)=1 and FnsnR(u)=1 are not satisfied, and PvL(u,b)=1 and PvR(u,b)=1 are not satisfied, the band is determined to be of noise (non-stationary noise), and Fnz(u,b)=2 is set.

The noise band flag Fnz(u,b) of each band common in the right and left channels set for each frame in the noise/non-noise determination section 27S is supplied to the a computation section 30S. In the a computation section 30S, in order to compute the a priori SNRs “ζL(u,b) and ζR(u,b)” of each band for each frame, a weighting coefficient α(u,b) common in the right and left channels is computed (refer to formula (14)). In this case, the weighting coefficient α(u,b) is updated to be approximate to the maximum value αMAX(b) in the band b (Fnz(u,b)=1,2) determined to be of noise, and immediately set to the minimum value αMIN(b) in the band b (Fnz(u,b)=0) determined to be of non-noise.

The noise band flag Fnz(u,b) of each band common in the right and left channels set for each frame in the noise/non-noise determination section 27S is supplied to the noise band power estimation sections 28L and 28R. In addition, the band powers BL(u,b) and BR(u,b) of each band computed for each frame in the band power computation sections 22L and 22R are supplied to the noise band power estimation sections 28L and 28R. In the noise band power estimation sections 28L and 28R, the noise band power estimation values DL(u,b) and DR(u,b) of each band are estimated for each frame.

In the noise band power estimation sections 28L and 28R, the noise band power estimation values DL(u,b) and DR(u,b) are updated only for a band in which Fnz(u,b)=1, 2, in other words, a band of noise, based on the noise band flag Fnz(u,b). For example, updating is performed using the band powers BL(u,b) and BR(u,b) and an index weight μnz (refer to formula (11)). In this case, different values of the index weight μnz are used for stationary noise and non-stationary noise.

In other words, when Fnz(u,b)=1 in the case of stationary noise, it is set that μnz=μnz1 is set to be a value, for example, from about 0.9 to 1.0 to the extent that the noise band power estimation values DL(u,b) and DR(u,b) follows actual changes in noise and that auditory discomfort does not occur. In addition, when Fnz(u,b)=2 in the case of non-stationary noise, it is set that μnz=μnz2 is set to be a relatively small value which is smaller than μnz1, for example a value between about 0.7 and 0.8. Accordingly, since the speed of following changes in noise in non-stationary noise increases more than the speed of following changes in noise in stationary noise, it is possible to avoid inconvenience that a reduction in noise is insufficiently attained or an adverse effect thereof arises in the voice.

The noise band power estimation values DL(u,b) and DR(u,b) of each band estimated for each frame in the noise band power estimation sections 28L and 28R are supplied to the a posteriori SNR computation sections 29L and 29R. In addition, the band powers BL(u,b) and BR(u,b) of each band computed for each frame in the band power computation sections 22L and 22R are supplied to the a posteriori SNR computation sections 29L and 29R. In the a posteriori SNR computation sections 29L and 29R, the a posteriori SNRs “γL(u,b) and γR(u,b)” of each band are computed for each frame (refer to formula (12)). In this case, the band powers BL(u,b) and BR(u,b) and the noise band power estimation values DL(u,b) and DR(u,b) are used.

The a posteriori SNRs “γL(u,b) and γR(u,b)” of each band computed for each frame in the a posteriori SNR computation sections 29L and 29R are supplied to the a priori SNR computation sections 31L and 31R. In addition, the weighting coefficient α(u,b) of each band common in the right and left channels computed for each frame in the a computation section 30S is supplied to the a priori SNR computation sections 31L and 31R. Furthermore, the noise suppression gains G′L(u,b) and G′R(u,b) of each band of the previous frame modified in the voiced sound detection sections 23L and 23R are supplied to the a priori SNR computation sections 31L and 31R.

In the a priori SNR computation sections 31L and 31R, the a priori SNRs “ζL(u,b) and ζR(u,b)” of each band are computed (refer to formula (15)). In the a priori SNR computation section 31L, the a priori SNR “ζL(u,b)” of each band is computed for each frame. In this case, the a posteriori SNRs “γL(u−1,b) and γL(u,b)” of the previous frame and the current frame, the noise suppression gain G′L(u−1,b) of the previous frame, and the weighting coefficient α(u,b) are used. In addition, in the a priori SNR computation section 31R, the a priori SNR “ζR(u,b)” of each band is computed. In this case, the a posteriori SNRs “γR(u−1,b) and γR(u,b)” of the previous frame and the current frame, the noise suppression gain G′R(u−1,b) of the previous frame, and the weighting coefficient α(u,b) are used for each frame.

As described above, the weighting coefficient α(u,b) of each band common in the right and left channels is updated to be approximate to the maximum value αMAX(b) in the band b determined to be of noise and immediately set to the minimum value αMIN(b) in the band b determined to be of non-noise. For this reason, the a priori SNRs “ζL(u,b) and ζR(u,b)” are computed so that non-noise such as a voice generally having wild fluctuation is followed quickly while noise assumed to have stationarity is followed slowly.

The a posteriori SNRs “γL(u,b) and γR(u,b)” of each band computed for each frame in the a posteriori SNR computation sections 29L and 29R are supplied to the noise suppression gain computation sections 32L and 32R. In addition, the a priori SNRs “ζL(u,b) and ζR(u,b)” of each band computed for each frame by the a priori SNR computation sections 31L and 31R are supplied to the noise suppression gain computation sections 32L and 32R. In the noise suppression gain computation sections 32L and 32R, the noise suppression gains GL(u,b) and GR(u,b) of each band are computed for each frame based on the a posteriori SNRs “γL(u,b) and γR(u,b)” and the a priori SNRs “ζL(u,b) and ζR(u,b)” (refer to formula (16)).

The noise suppression gains GL(u,b) and GR(u,b) of each band computed for each frame in the noise suppression gain computation sections 32L and 32R are supplied to the noise suppression gain modification sections 33L and 33R. In the noise suppression gain modification sections 33L and 33R, the modified noise suppression gains G′L(u,b) and G′R(u,b) are computed for each frame. In this case, a limit is imposed on the noise suppression gains GL(u,b) and GR(u,b) of each band based on the lower limit value GMIN(b) of the noise suppression gains that are set in advance for each band.

The noise suppression gains G′L(u,b) and G′R(u,b) of each band modified for each frame in the noise suppression gain modification sections 33L and 33R are supplied to the filter constituting sections 34L and 34R. In the filter constituting sections 34L and 34R, noise suppression gains GfL(u,f) and GfR(u,f) corresponding to each Fourier coefficient are computed for each frame based on the noise suppression gains G′L(u,b) and G′R(u,b). The noise suppression gains corresponding to each Fourier coefficient computed in this manner for each frame in the filter constituting sections 34L and 34R are supplied to the Fourier coefficient modification units 16L and 16R as outputs of the noise suppression gain generation unit 15S.

As described above, the noise suppressing device 10S shown in FIG. 13 is a configuration example to be applied to stereo signals, but the noise suppression gain generation unit 15S basically has the same configuration as the noise suppression gain generation unit 15 of the noise suppressing device 10 shown in FIG. 4. Thus, the same effect as that of the noise suppressing device 10 shown in FIG. 4 can also be obtained in the noise suppressing device 10S shown in FIG. 13.

In addition, in the noise/non-noise determination section 27S of the noise suppression gain generation unit 15S of the noise suppressing device 10S shown in FIG. 13, the noise band flag Fnz(u,b) of each band common in the right and left channels is set for each frame. In this case, the voiced sound flags FvL(u) and FvR(u) and the band powers BL(u,b) and BR(u,b) of each band are used. Then, in the noise band power estimation sections 28L and 28R, the noise band flag Fnz(u,b) of each band common in the right and left channels set in the noise/non-noise determination section 27S for each frame is used to estimate the noise band power estimation values DL(u,b) and DR(u,b) of each band.

In this manner, determination of noise or non-noise in the right and left channels is commonly performed, and a common determination result is used in the noise band power estimation sections 28L and 28R. Thus, in the noise suppression gain generation unit 15S of the noise suppressing device 10S shown in FIG. 13, it is possible to suppress the occurrence of an unintended difference in the amplitudes of the noise suppression gains GL(u,b) and GR(u,b) caused by estimation errors in the noise band power estimation values DL(u,b) and DR(u,b) of the right and left channels. Accordingly, it is possible to avoid collapse of orientation caused by inconsistency of the right and left channels.

Note that the noise suppressing device 10S shown in FIG. 13 is a configuration example to be applied to noise suppression of stereo signals. Detailed description thereof will be omitted, but it is certain that a noise suppressing device applied to noise suppression of multi-channel signals which is three or more channels can have the same configuration using determination of noise or non-noise commonly to each of the channels.

### 3. Modification Example

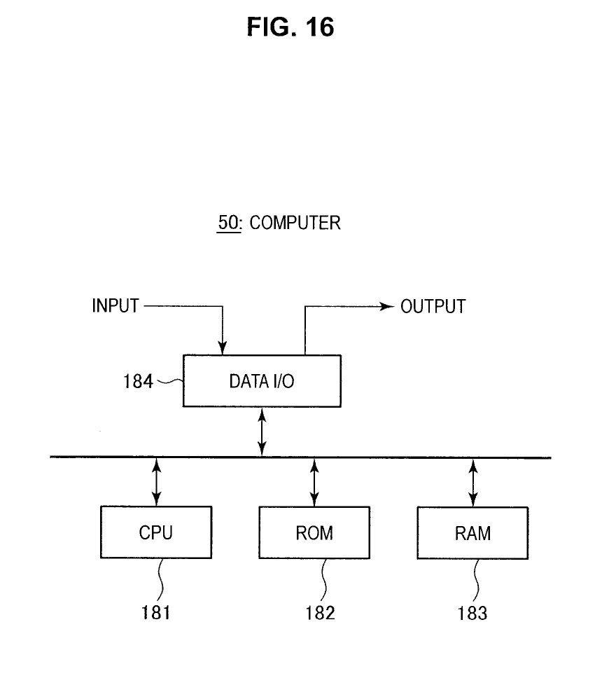

Note that the noise suppressing devices 10 and 10S according to the above embodiments can be configured by hardware or by software for the same process. FIG. 16 shows a configuration example of a computer 50 that performs processes using software. This computer 50 includes a CPU 181, a ROM 182, a RAM 183, and a data input and output unit (data I/O) 184.

The ROM 182 stores processing programs of the CPU 181 and other necessary data. The RAM 183 functions as a work area of the CPU 181. The CPU 181 reads the processing programs stored in the ROM 182 as necessary, transfers the read processing programs to the RAM 183 to develop, reads the developed processing programs, and executes a noise suppressing process.

In the computer 50, an input signal (a monaural or stereo signal) is input via the data I/O 184, and accumulated in the RAM 183. For the input signal accumulated in the RAM 183, the same noise suppressing process as that in the above-described embodiments is performed by the CPU 181. Then, an output signal is output externally as a processing result in which noise is suppressed via the data I/O 184.

Additionally, the present technology may also be configured as below.

(1) A noise suppressing device including:

a framing unit that frames an input signal by dividing the input signal into frames having a predetermined frame length;

a band division unit that obtains a band division signal by dividing a framed signal obtained in the framing unit into a plurality of bands;

a band power computation unit that obtains a band power from each band division signal obtained in the band division unit;

a noise determination unit that determines whether each band is stationary noise or non-stationary noise based on a characteristic of the framed signal;

a noise band power estimation unit that estimates a band power of noise of each band from the band power of each band division signal obtained in the band power computation unit and a determination result of the noise determination unit;

a noise suppression gain decision unit that decides a noise suppression gain of each band based on the band power of each band division signal obtained in the band power computation unit and the band power of noise of each band estimated in the noise band power estimation unit;

a noise suppression unit that obtains a band division signal whose noise is suppressed by applying the noise suppression gain of each band decided in the noise suppression gain decision unit to each band division signal obtained in the band division unit;

a band synthesis unit that obtains a framed signal whose noise is suppressed by performing band synthesis on each band division signal obtained in the noise suppression unit; and

a frame synthesis unit that obtains an output signal whose noise is suppressed by performing frame synthesis on the framed signal of each frame obtained in the band synthesis unit,

wherein the noise band power estimation unit increases speed of following a noise change in the non-stationary noise to be higher than speed of following a noise change in the stationary noise.

(2) The noise suppressing device according to (1),

wherein the noise band power estimation unit obtains an estimated power of noise of a current frame by performing weighted addition on the band power of the current frame obtained in the band power computation unit and a band power of noise estimated in a frame one frame before the current frame for each band, and

weight of the band power of the current frame in the non-stationary noise is set to be larger than weight of the band power of the current frame in the stationary noise.

(3) The noise suppressing device according to (1) or (2), wherein, in determining whether a predetermined band is noise, the noise determination unit uses, as a condition, that a peak of a spectrum resulting from a voice is not present in a corresponding band.
(4) The noise suppressing device according to any one of (1) to (3),

wherein the noise suppression gain decision unit includes an SNR computation section that computes an SNR from the band power of each band division signal obtained in the band power computation unit and the band power of noise of each band estimated in the noise band power estimation unit for each band, and an SNR smoothing section that performs smoothing on an SNR computed in the SNR computation section for each band, and decides a noise suppression gain of each band based on the SNR of each band smoothed in the SNR smoothing section, and

wherein the SNR smoothing section changes a smoothing coefficient based on the determination result of the noise determination unit and a frequency band.

(5) The noise suppressing device according to (4), wherein the noise suppression gain decision unit decides the noise suppression gain of each band based on the SNR of each band smoothed in the SNR smoothing section and the SNR computed in the SNR computation section.
(6) The noise suppressing device according to (4), wherein the noise suppression gain decision unit sets a ratio of a band power of a signal of the current frame to the estimated band power of noise to be a first SNR and sets a ratio of an amount obtained by multiplying a band power of a signal of a previous frame by a noise suppression gain to an estimated band power of noise of the previous frame to be a second SNR, and decides the noise suppression gain using the first SNR and the second SNR for each band.
(7) The noise suppressing device according to any one of (4) to (6), further including:

a noise suppression gain modification unit that modifies a value of a noise suppression gain to a lower limit value that is set in advance when the noise suppression gain decided in the noise suppression gain decision unit is smaller than the lower limit value,

wherein the noise suppression unit uses the noise suppression gain modified in the noise suppression gain modification unit.

(8) A noise suppressing device including:

a plurality of framing units that perform framing by performing division into frames having predetermined frame lengths of a respective plurality of channels;

a plurality of band division units that obtain band division signals by dividing framed signals obtained in the plurality of framing units into a plurality of bands, respectively;

a plurality of band power computation units that obtain band powers from the respective band division signals obtained in the plurality of band division units;

a noise determination unit that determines whether each band is stationary noise or non-stationary noise based on characteristics of the framed signals of the plurality of channels;

a plurality of noise band power estimation units that estimate band powers of noise of respective bands from the band powers of respective band division signals obtained in the plurality of band power computation units and a determination result of the noise determination unit;

a plurality of noise suppression gain decision units that decide noise suppression gains of respective bands based on the band powers of the respective band division signals obtained in the plurality of band power computation units and the band powers of noise of the respective bands estimated in the plurality of noise band power estimation units;

a plurality of noise suppression units that obtain band division signals whose noise is suppressed by applying noise suppression gains of the respective bands decided in the plurality of noise suppression gain decision units to the respective band division signals obtained in the plurality of band division units;

a plurality of band synthesis units that obtain framed signals whose noise is suppressed by performing band synthesis on the respective band division signals obtained in the plurality of noise suppression units; and

a frame synthesis unit that obtains output signals whose noise is suppressed by performing frame synthesis on the framed signals of respective frames obtained in the plurality of band synthesis units,

wherein the noise band power estimation unit increases speed of following a noise change in the non-stationary noise to be higher than speed of following a noise change in the stationary noise.

(9) The noise suppressing device according to (8), wherein the noise determination unit sequentially sets each band to be a determination band, determines whether the determination band is stationary noise or non-stationary noise in channels, and determines that the determination band is stationary noise when the band is determined to be stationary noise in all of the channels, and that the determination band is non-stationary noise when the band is determined to be non-stationary noise in all of the channels.
(10) A noise suppressing method including:

framing an input signal by dividing the input signal into frames having a predetermined frame length;

dividing a framed signal obtained in the framing into a plurality of bands to obtain a band division signal;

computing to obtain a band power from each band division signal obtained in the band-dividing;

determining whether each band is stationary noise or non-stationary noise based on a characteristic of the framed signal;

estimating a band power of noise of each band from the band power of each band division signal obtained in the band power computing and a determination result of the noise determining;

deciding a noise suppression gain of each band based on the band power of each band division signal obtained in the band power computing and the band power of noise of each band estimated in the noise band power estimating;

suppressing noise to obtain the band division signal whose noise is suppressed by applying the noise suppression gain of each band decided in the noise suppression gain deciding to each band division signal obtained in the band-dividing;

performing band synthesis on each band division signal obtained in the noise suppressing to obtain a framed signal whose noise is suppressed; and

performing frame synthesis on the framed signal of each frame obtained in the band synthesizing to obtain an output signal whose noise is suppressed,

wherein, in the noise band power estimating, speed of following a noise change in the non-stationary is increased to be higher than speed of following a noise change in the stationary noise.

(11) A program of causing a computer to function as:

a framing means that frames an input signal by dividing the input signal into frames having a predetermined frame length;

a band division means that obtains a band division signal by dividing a framed signal obtained in the framing means into a plurality of bands;

a band power computation means that obtains a band power from each band division signal obtained in the band division means;

a noise determination means that determines whether each band is stationary noise or non-stationary noise based on a characteristic of the framed signal;

a noise band power estimation means that estimates a band power of noise of each band from the band power of each band division signal obtained in the band power computation means and a determination result of the noise determination means;

a noise suppression gain decision means that decides a noise suppression gain of each band based on the band power of each band division signal obtained in the band power computation means and the band power of noise of each band estimated in the noise band power estimation means;

a noise suppression means that obtains a band division signal whose noise is suppressed by applying the noise suppression gain of each band decided in the noise suppression gain decision means to each band division signal obtained in the band division means;

a band synthesis means that obtains a framed signal whose noise is suppressed by performing band synthesis on each band division signal obtained in the noise suppression means; and

a frame synthesis means that obtains an output signal whose noise is suppressed by performing frame synthesis on the framed signal of each frame obtained in the band synthesis means,

wherein the noise band power estimation means increases speed of following a noise change in the non-stationary noise to be higher than speed of following a noise change in the stationary noise.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-009240 filed in the Japan Patent Office on Jan. 19, 2012, the entire content of which is hereby incorporated by reference.

What is claimed is:

1. A noise suppressing device comprising:
a framing unit that frames an input signal by dividing the input signal into frames having a predetermined frame length;
a band division unit that obtains a band division signal by dividing a framed signal obtained in the framing unit into a plurality of bands;
a band power computation unit that obtains a band power from each band division signal obtained in the band division unit;
a noise determination unit that determines whether each band is stationary noise or non-stationary noise based on a characteristic of the framed signal;
a noise band power estimation unit that estimates a band power of noise of each band from the band power of each band division signal obtained in the band power computation unit and a determination result of the noise determination unit;
a noise suppression gain decision unit that decides a noise suppression gain of each band based on the band power of each band division signal obtained in the band power computation unit and the band power of noise of each band estimated in the noise band power estimation unit;
a noise suppression unit that obtains a band division signal whose noise is suppressed by applying the noise suppression gain of each band decided in the noise suppression gain decision unit to each band division signal obtained in the band division unit;
a band synthesis unit that obtains a framed signal whose noise is suppressed by performing band synthesis on each band division signal obtained in the noise suppression unit; and
a frame synthesis unit that obtains an output signal whose noise is suppressed by performing frame synthesis on the framed signal of each frame obtained in the band synthesis unit,
wherein the noise band power estimation unit increases speed of following a noise change in the non-stationary noise to be higher than speed of following a noise change in the stationary noise.

2. The noise suppressing device according to claim 1,
wherein the noise band power estimation unit obtains an estimated power of noise of a current frame by performing weighted addition on the band power of the current frame obtained in the band power computation unit and a band power of noise estimated in a frame one frame before the current frame for each band, and
weight of the band power of the current frame in the non-stationary noise is set to be larger than weight of the band power of the current frame in the stationary noise.

3. The noise suppressing device according to claim 1, wherein, in determining whether a predetermined band is noise, the noise determination unit uses, as a condition, that a peak of a spectrum resulting from a voice is not present in a corresponding band.

4. The noise suppressing device according to claim 1,
wherein the noise suppression gain decision unit includes an SNR computation section that computes an SNR from the band power of each band division signal obtained in the band power computation unit and the band power of noise of each band estimated in the noise band power estimation unit for each band, and an SNR smoothing section that performs smoothing on an SNR computed in the SNR computation section for each band, and decides a noise suppression gain of each band based on the SNR of each band smoothed in the SNR smoothing section, and
wherein the SNR smoothing section changes a smoothing coefficient based on the determination result of the noise determination unit and a frequency band.

5. The noise suppressing device according to claim 4, wherein the noise suppression gain decision unit decides the noise suppression gain of each band based on the SNR of each band smoothed in the SNR smoothing section and the SNR computed in the SNR computation section.

6. The noise suppressing device according to claim 4, wherein the noise suppression gain decision unit sets a ratio of a band power of a signal of the current frame to the estimated band power of noise to be a first SNR and sets a ratio of an amount obtained by multiplying a band power of a signal of a previous frame by a noise suppression gain to an estimated band power of noise of the previous frame to be a second SNR, and decides the noise suppression gain using the first SNR and the second SNR for each band.

7. The noise suppressing device according to claim 4, further comprising:
a noise suppression gain modification unit that modifies a value of a noise suppression gain to a lower limit value that is set in advance when the noise suppression gain decided in the noise suppression gain decision unit is smaller than the lower limit value,
wherein the noise suppression unit uses the noise suppression gain modified in the noise suppression gain modification unit.

8. A noise suppressing device comprising:
a plurality of framing units that perform framing by performing division into frames having predetermined frame lengths of a respective plurality of channels;
a plurality of band division units that obtain band division signals by dividing framed signals obtained in the plurality of framing units into a plurality of bands, respectively;
a plurality of band power computation units that obtain band powers from the respective band division signals obtained in the plurality of band division units;
a noise determination unit that determines whether each band is stationary noise or non-stationary noise based on characteristics of the framed signals of the plurality of channels;
a plurality of noise band power estimation units that estimate band powers of noise of respective bands from the band powers of respective band division signals obtained in the plurality of band power computation units and a determination result of the noise determination unit;
a plurality of noise suppression gain decision units that decide noise suppression gains of respective bands based on the band powers of the respective band division signals obtained in the plurality of band power computation units and the band powers of noise of the respective bands estimated in the plurality of noise band power estimation units;
a plurality of noise suppression units that obtain band division signals whose noise is suppressed by applying noise suppression gains of the respective bands decided in the plurality of noise suppression gain decision units to the respective band division signals obtained in the plurality of band division units;
a plurality of band synthesis units that obtain framed signals whose noise is suppressed by performing band synthesis on the respective band division signals obtained in the plurality of noise suppression units; and
a frame synthesis unit that obtains output signals whose noise is suppressed by performing frame synthesis on the framed signals of respective frames obtained in the plurality of band synthesis units,
wherein the noise band power estimation unit increases speed of following a noise change in the non-stationary noise to be higher than speed of following a noise change in the stationary noise.

9. The noise suppressing device according to claim 8, wherein the noise determination unit sequentially sets each band to be a determination band, determines whether the determination band is stationary noise or non-stationary noise in respective channels, and determines that the determination band is stationary noise when the band is determined to be stationary noise in all of the channels, and that the determination band is non-stationary noise when the band is determined to be non-stationary noise in all of the channels.

10. A noise suppressing method comprising:
framing an input signal by dividing the input signal into frames having a predetermined frame length;
dividing a framed signal obtained in the framing into a plurality of bands to obtain a band division signal;
computing to obtain a band power from each band division signal obtained in the band-dividing;
determining whether each band is stationary noise or non-stationary noise based on a characteristic of the framed signal;
estimating a band power of noise of each band from the band power of each band division signal obtained in the band power computing and a determination result of the noise determining;
deciding a noise suppression gain of each band based on the band power of each band division signal obtained in the band power computing and the band power of noise of each band estimated in the noise band power estimating;
suppressing noise to obtain the band division signal whose noise is suppressed by applying the noise suppression gain of each band decided in the noise suppression gain deciding to each band division signal obtained in the band-dividing;
performing band synthesis on each band division signal obtained in the noise suppressing to obtain a framed signal whose noise is suppressed; and
performing frame synthesis on the framed signal of each frame obtained in the band synthesizing to obtain an output signal whose noise is suppressed,
wherein, in the noise band power estimating, speed of following a noise change in the non-stationary is increased to be higher than speed of following a noise change in the stationary noise.

11. A program of causing a computer to function as:
a framing means that frames an input signal by dividing the input signal into frames having a predetermined frame length;
a band division means that obtains a band division signal by dividing a framed signal obtained in the framing means into a plurality of bands;
a band power computation means that obtains a band power from each band division signal obtained in the band division means;
a noise determination means that determines whether each band is stationary noise or non-stationary noise based on a characteristic of the framed signal;
a noise band power estimation means that estimates a band power of noise of each band from the band power of each band division signal obtained in the band power computation means and a determination result of the noise determination means;
a noise suppression gain decision means that decides a noise suppression gain of each band based on the band power of each band division signal obtained in the band power computation means and the band power of noise of each band estimated in the noise band power estimation means;
a noise suppression means that obtains a band division signal whose noise is suppressed by applying the noise suppression gain of each band decided in the noise suppression gain decision means to each band division signal obtained in the band division means;
a band synthesis means that obtains a framed signal whose noise is suppressed by performing band synthesis on each band division signal obtained in the noise suppression means; and
a frame synthesis means that obtains an output signal whose noise is suppressed by performing frame synthesis on the framed signal of each frame obtained in the band synthesis means,
wherein the noise band power estimation means increases speed of following a noise change in the non-stationary noise to be higher than speed of following a noise change in the stationary noise.
